(19) United States
(12) Patent Application Publication
(10) Pub. No.: US 2010/0217584 A1
(43) Pub. Date: Aug. 26, 2010

(54) SPEECH ANALYSIS DEVICE, SPEECH ANALYSIS AND SYNTHESIS DEVICE, CORRECTION RULE INFORMATION GENERATION DEVICE, SPEECH ANALYSIS SYSTEM, SPEECH ANALYSIS METHOD, CORRECTION RULE INFORMATION GENERATION METHOD, AND PROGRAM

(76) Inventors: Yoshifumi Hirose, Kyoto (JP); Takahiro Kamai, Kyoto (JP)

Correspondence Address: WENDEROTH, LIND & PONACK L.L.P., 1030 15th Street, N.W., Suite 400 East, Washington, DC, 20005-1503, US

(21) Appl. No.: 12/773,168

(22) Filed: May 4, 2010

Related U.S. Application Data
(63) Continuation of application No. PCT/JP2009/004514, filed on Sep. 11, 2009.

(30) Foreign Application Priority Data
Sep. 16, 2008 (JP) 2008-237050

(51) Int. Cl. G10L 11/04; G10L 13/00; G10L 21/02

(52) U.S. Cl. 704/206; 704/224; 704/258; 704/226; 704/E11.003; 704/E21.002; 704/E13.001

(57) ABSTRACT

A speech analysis device which accurately analyzes an aperiodic component included in speech in a practical environment where there is background noise includes: a frequency band division unit which divides, into bandpass signals each associated with a corresponding one of frequency bands, an input signal representing a mixed sound of background noise and speech; a noise interval identification unit which identifies a noise interval and a speech interval of the input signal; an SNR calculation unit which calculates an SN ratio; a correlation function calculation unit which calculates an autocorrelation function of each bandpass signal; a correction amount determination unit which determines a correction amount for an aperiodic component ratio, based on the calculated SN ratio; and an aperiodic component ratio calculation unit which calculates, for each frequency band, an aperiodic component ratio of the aperiodic component, based on the determined correction amount and the calculated autocorrelation function.

### CROSS REFERENCE TO RELATED APPLICATION

This is a continuation application of PCT application No. PCT/JP2009/004514 filed Sep. 11, 2009, designating the United States of America.

### BACKGROUND OF THE INVENTION

(1) Field of the Invention

The present invention relates to a technique for analyzing aperiodic components of speech.

(2) Description of the Related Art

In recent years, the development of speech synthesis techniques has enabled generation of very high-quality synthesized speech. The use of such synthesized speech is centered on uniform purposes, such as reading off news texts in announcer style.

Meanwhile, among services available for mobile phones, a service in which a voice message of a celebrity can be used instead of a ringtone has been provided, and speech having distinctive features (synthesized speech highly representing personal speech or synthesized speech having a distinct prosody and voice quality, such as the speech style of a high-school girl or speech with a distinct intonation of the Kansai region in Japan) has started to be distributed as a kind of content.

As another aspect of the use of the synthesized speech, a demand for creating distinctive speech to be heard by the other party is expected to grow in order that further amusement in interpersonal communication is sought.

One of factors determining distinctiveness of speech is aperiodic component. Voiced speech having vocal cord vibration includes a periodic component in which a pitch pulse repeatedly appears, and an aperiodic component. The aperiodic component includes, for example, fluctuations in pitch period, pitch amplitude, and pitch pulse waveform, and noise components. The aperiodic component significantly influences speech naturalness, and at the same time greatly contributes to personal characteristics of a speech utterer. (Non-patent Reference 1: Ohtsuka, Takahiro and Hideki Kasuya. (2001, October). Nature of Aperiodicity of Continuous Speech in Time-Frequency Domain. Proceedings from Lectures of Japan Acoustic Society, 265-266.)

FIG. 1(A) and FIG. 1(B) are spectrograms of vowels /a/ each having a different amount of aperiodic component. The horizontal axis indicates a period of time, and the vertical axis indicates a frequency. In FIG. 1(A) and FIG. 1(B), belt-shaped horizontal lines each indicate a harmonic that is a signal component of a frequency which is an integer multiple of the fundamental frequency.

FIG. 1(A) shows a case where the amount of aperiodic component is small and the harmonic can be seen in up to a high-frequency band. FIG. 1(B) shows a case where the amount of aperiodic component is large and the harmonic can be seen in up to a mid-frequency band (indicated by X1) but cannot be seen in a frequency band higher than the mid-frequency band.

As in the above case, speech having a large amount of aperiodic component is frequently seen in, for example, a husky voice. In addition, a large amount of aperiodic component is seen in a soft voice for reading a story to a child.

Thus, accurate analysis of aperiodic component is very important in reproducing speech having personal distinctiveness. Further, appropriately converting aperiodic component allows the converted aperiodic component to be applied to speaker conversion.

An aperiodic component in a high-frequency band is characterized by not only fluctuations in pitch amplitude and pitch period but also a fluctuation in pitch waveform and presence or absence of noise components, and destroys a harmonic structure in the same frequency band. In order to specify a frequency band where the aperiodic component is dominant, Non-patent Reference 1 uses a method of determining a frequency band where the magnitude of aperiodic component is great, based on the magnitude of autocorrelation functions of bandpass signals in different frequency bands.

FIG. 2 is a block diagram showing a functional configuration of a speech analysis device 900 of Non-patent Reference 1 that analyzes aperiodic components included in speech.

The speech analysis device 900 includes a temporal axis warping unit 901, a band division unit 902, correlation function calculation units 903a, 903b, . . . , and 903n, and a boundary frequency calculation unit 904.

The temporal axis warping unit 901 divides an input signal into frames having a predetermined length of time, and performs temporal axis warping on each of the frames.

The band division unit 902 divides the signal on which the temporal axis warping unit 901 has performed the temporal axis warping, into bandpass signals each associated with a corresponding one of predetermined frequency bands.

The correlation function calculation units 903a, 903b, . . . , and 903n each calculate an autocorrelation function associated with a corresponding one of the bandpass signals obtained through the division performed by the band division unit 902.

The boundary frequency calculation unit 904 calculates a boundary frequency between a frequency band where a periodic component is dominant and a frequency band where an aperiodic component is dominant, using the autocorrelation functions calculated by the correlation function calculation units 903a, 903b, . . . , and 903n.

After the temporal axis warping unit 901 performs the temporal axis warping, the band division unit 902 performs frequency division on input speech. An autocorrelation function is calculated for a frequency component of each of frequency bands divided from the input speech, and an autocorrelation value in temporal shift for a fundamental period T₀ is calculated for the frequency component of each of the frequency bands. It is possible to determine the boundary frequency serving as a division between the frequency band where the periodic component is dominant and the frequency band where the aperiodic component is dominant, based on the autocorrelation value calculated for the frequency component of each of the frequency bands.

### SUMMARY OF THE INVENTION

The above-mentioned method makes it possible to calculate the boundary frequency having the aperiodic component included in the input speech. In actual application, however, it is not always possible to expect that a speech recording environment is as quiet as a laboratory. For example, when the application of the method to a mobile phone is considered, the recording environment is often, for instance, a street or a railway station where there is relatively much noise.

In such a noisy environment, the aperiodic component analysis method of Non-patent Reference 1 has a problem that an aperiodic component is overestimated, because an autocorrelation function of a signal is calculated into a value lower than the value actually is due to the influence of background noise.

FIGS. 3A to 3C are diagrams showing a situation in which background noise causes a harmonic to be buried under noise. FIG. 3(A) shows a waveform of a speech signal on which the background noise is experimentally superimposed. FIG. 3(B) shows a spectrogram of the speech signal on which the background noise is superimposed, and FIG. 3(C) shows a spectrogram of an original speech signal on which the background noise is not superimposed.

Harmonics appear in a high-frequency band as shown in FIG. 3(C), and an original speech signal has few aperiodic components. However, when background noise is superimposed on the speech signal, the speech signal is buried under the background noise as shown in FIG. 3(B), and it is not easy to observe the harmonics. Accordingly, with the conventional technique, autocorrelation values of bandpass signals are reduced, and thus more aperiodic components are calculated than are actually calculated.

The present invention has been devised to solve the above conventional problem, and an object of the present invention is to provide an analysis method which makes it possible to accurately analyze aperiodic components in a practical environment where there is background noise.

In order to solve the above conventional problem, a speech analysis device according to an aspect of the present invention is a speech analysis device which analyzes an aperiodic component included in speech from an input signal representing a mixed sound of background noise and the speech, and includes: a frequency band division unit which divides the input signal into bandpass signals each associated with a corresponding one of frequency bands; a noise interval identification unit which identifies a noise interval in which the input signal represents only the background noise and a speech interval in which the input signal represents the background noise and the speech; an SNR calculation unit which calculates an SN ratio which is a ratio between power of each of the bandpass signals divided from the input signal in the speech interval and power of each of the bandpass signals divided from the input signal in the noise interval; a correlation function calculation unit which calculates an autocorrelation function of each of the bandpass signals divided from the input signal in the speech interval; a correction amount determination unit which determines a correction amount for an aperiodic component ratio, based on the calculated SN ratio; and an aperiodic component ratio calculation unit which calculates, for each of the frequency bands, an aperiodic component ratio of the aperiodic component included in the speech, based on the determined correction amount and the calculated autocorrelation function.

Here, the correction amount determination unit may determine, as the correction amount for the aperiodic component ratio, a correction amount that increases as the calculated SN ratio decreases. Furthermore, the aperiodic component ratio calculation unit may calculate, as the aperiodic component ratio, a ratio that increases as a correction correlation value decreases, the correction correlation value being obtained by subtracting the correction amount from a value of the autocorrelation function in temporal shift for one period of a fundamental frequency of the input signal.

Moreover, the correction amount determination unit may hold in advance correction rule information indicating a correspondence of an SN ratio to a correction amount, refer to a correction amount corresponding to the calculated SN ratio according to the correction rule information, and determine the correction amount referred to as the correction amount for the aperiodic component ratio.

Here, the correction amount determination unit may hold in advance an approximation function as the correction rule information, calculate a value of the approximation function based on the calculated SN ratio, and determine the calculated value as the correction amount for the aperiodic component ratio, the approximation function indicating a relationship between a correction amount and an SN ratio, the relationship being learned based on a difference between an autocorrelation value of speech and an autocorrelation value in the case where noise having a known SN ratio is superimposed on the speech.

Furthermore, the speech analysis device may include a fundamental frequency normalization unit which normalizes a fundamental frequency of the speech into a predetermined target frequency, wherein the aperiodic component ratio calculation unit may calculate the aperiodic component ratio using the speech having the fundamental frequency normalized.

The present invention can be realized not only as the above speech analysis device but also as a speech analysis method and a program. Moreover, the present invention can be realized as a correction rule information generating device which generates correction rule information which the speech analysis device uses in determining the amount of correction, a correction rule information generating method, and a program. Further, the present invention can be applied to a speech analysis and synthesis device and a speech analysis system.

The speech analysis device according to the aspect of the present invention makes it possible to remove influence of noise on an aperiodic component and accurately analyze the aperiodic component for speech recorded in a noisy environment, by correcting an aperiodic component ratio based on an SN ratio of each of frequency bands.

In other words, the speech analysis device according to the aspect of the present invention makes it possible to accurately analyze an aperiodic component included in speech even in a practical environment where there is background noise such as a street.

### FURTHER INFORMATION ABOUT TECHNICAL BACKGROUND TO THIS APPLICATION

The disclosure of Japanese Patent Application No. 2008-237050 filed on Sep. 16, 2008 including specification, drawings and claims is incorporated herein by reference in its entirety.

The disclosure of PCT application No. PCT/JP2009/004514 filed, Sep. 11, 2009, including specification, drawings and claims is incorporated herein by reference in its entirety.

### BRIEF DESCRIPTION OF THE DRAWINGS

These and other objects, advantages and features of the invention will become apparent from the following description thereof taken in conjunction with the accompanying drawings that illustrate a specific embodiment of the invention. In the Drawings:

FIGS. 1(A) and 1(B) are diagrams each showing influence of spectrum depending on a difference in amount of aperiodic component;

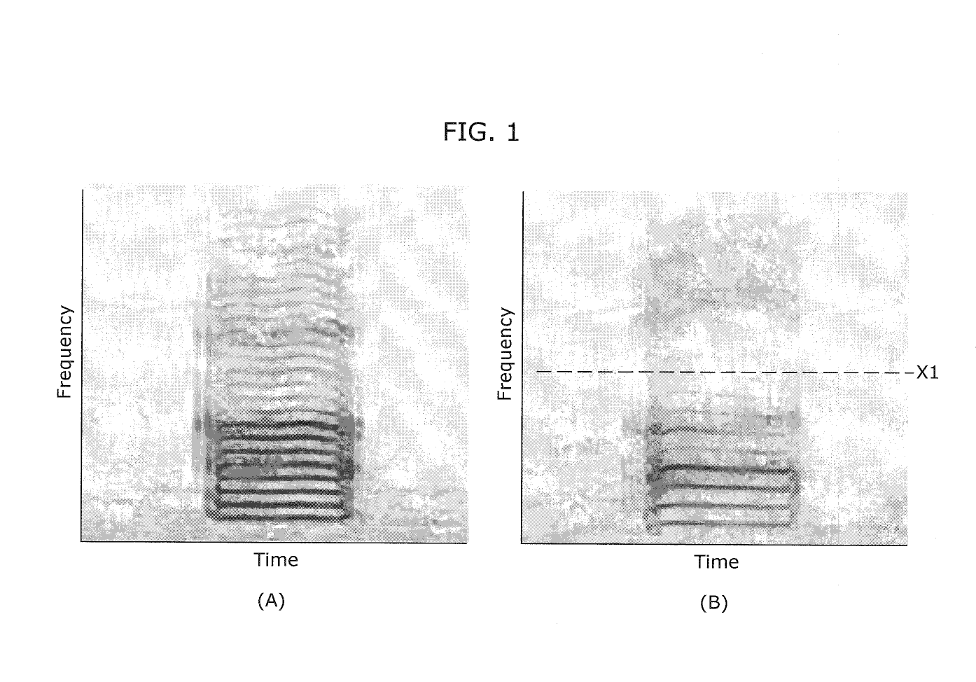

FIG. 2 is a block diagram showing a functional configuration of a conventional speech analysis device;

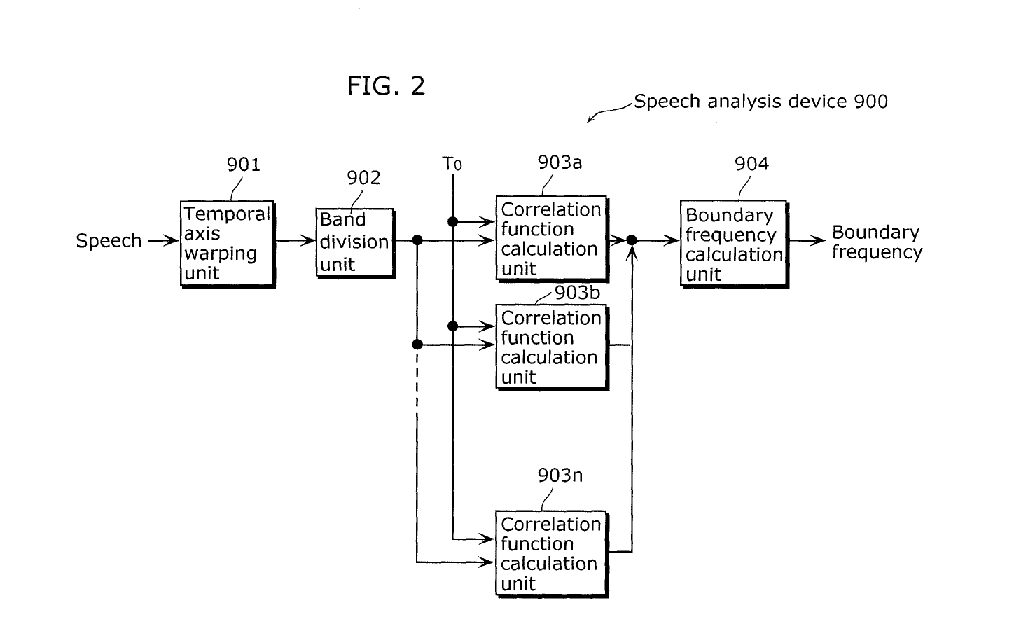

FIGS. 3(A) to 3(C) are diagrams each showing a situation in which background noise causes a harmonic to be buried under noise;

FIG. 4 is a block diagram showing an example of a functional configuration of a speech analysis device according to Embodiment 1 of the present invention;

FIG. 5 is a diagram showing an example of an amplitude spectrum of voiced speech;

FIG. 6 is a diagram showing an example of an autocorrelation function of each of bandpass signals which is associated with a corresponding one of divided bands of voiced speech;

FIG. 7 is a diagram showing an example of an autocorrelation value of each of bandpass signals in temporal shift for one period of a fundamental frequency of voiced speech;

FIGS. 8(A) to 8(H) are diagrams each showing influence of noise on an autocorrelation value;

FIG. 9 is a flowchart showing an example of operations of the speech analysis device according to Embodiment 1 of the present invention;

FIG. 10 is a diagram showing an example of a result of analysis of speech including few aperiodic components;

FIG. 11 is a diagram showing an example of a result of analysis of speech including many aperiodic components;

FIG. 12 is a block diagram showing an example of a functional configuration of a speech analysis device according to an application of the present invention;

FIGS. 13(A) and 13(B) are diagrams each showing an example of a voicing source waveform and an amplitude spectrum thereof;

FIG. 14 is a diagram showing an amplitude spectrum of a voicing source which a voicing source modeling unit models;

FIGS. 15(A) to 15(C) are diagrams showing a method of synthesizing a voicing source waveform which is performed by a synthesis unit;

FIGS. 16(A) and 16(B) are diagrams showing a method of generating a phase spectrum based on an aperiodic component;

FIG. 17 is a block diagram showing an example of a functional configuration of a correction rule information generation device according to Embodiment 2 of the present invention; and

FIG. 18 is a flowchart showing an example of operations of the correction rule information generating device according to Embodiment 2 of the present invention.

### DESCRIPTION OF THE PREFERRED EMBODIMENT(S)

The following describes embodiments of the present invention with reference to the drawings.

### Embodiment 1

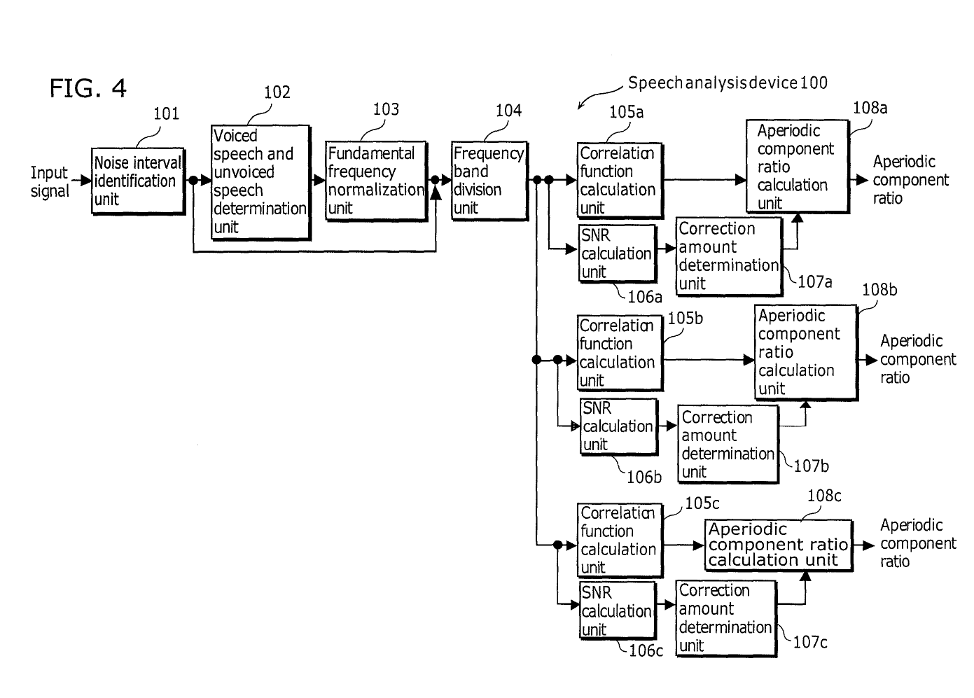

FIG. 4 is a block diagram showing an example of a functional configuration of a speech analysis device 100 according to Embodiment 1 of the present invention.

The speech analysis device 100 of FIG. 4 is a device that analyzes an aperiodic component included in speech from an input signal representing a mixed sound of background noise and the speech, and includes a noise interval identification unit 101, a voiced speech and unvoiced speech determination unit 102, a basic frequency normalization unit 103, a frequency band division unit 104, correlation function calculation units 105a, 105b, and 105c, SNR (Signal Noise Ratio) calculation units 106a, 106b, and 106c, correction amount determination units 107a, 107b, and 107c, and aperiodic component ratio calculation units 108a, 108b, and 108c.

The speech analysis device 100 may be, for example, a computer system including a central processor, a memory, and so on. In this case, a function of each of elements of the speech analysis device 100 is realized as a function of software to be exerted by the central processor executing a program stored in the memory. In addition, the function of each of the elements of the speech analysis device 100 can be realized by using a digital signal processing device or a dedicated hardware device.

The noise interval identification unit 101 receives an input signal representing a mixed sound of background noise and speech. The noise interval identification unit 101 divides the received input signal into frames per predetermined length of time, and identifies whether each of the frames is a background noise frame as a noise interval in which only background noise is represented or a speech frame as a speech interval in which background noise and speech are represented.

The voiced speech and unvoiced speech determination unit 102 receives, as an input, the frame identified as the speech frame by the noise interval identification unit 101, and determines whether the speech included in the input frame is voiced speech or unvoiced speech.

The fundamental frequency normalization unit 103 analyzes a fundamental frequency of the speech determined as the voiced speech by the voiced speech and unvoiced speech determination unit 102, and normalizes the fundamental frequency of the speech into a predetermined target frequency.

The frequency band division unit 104 divides, into bandpass signals each associated with a corresponding one of divided bands, the speech having the fundamental frequency normalized into the predetermined target frequency by the fundamental frequency normalization unit 103 and the background noise included in the frame identified as the background noise frame by the noise interval identification unit 101, the divided bands being predetermined different frequency bands. Hereinafter, a frequency band used in performing frequency division on speech and background noise is called a divided band.

The correlation function calculation units 105a, 105b, and 105c each calculate an autocorrelation function of a corresponding one of the bandpass signals obtained through the division performed by the frequency band division unit 104.

The SNR calculation units 106a, 106b, and 106c each calculate a ratio between power in the speech frame and power in the background noise frame as an SN ratio, for the corresponding one of the bandpass signals obtained through the division performed by the frequency band division unit 104.

The correction amount determination units 107a, 107b, and 107c each determine a correction amount for an aperiodic component ratio calculated for the corresponding one of the bandpass signals, based on the SN ratio calculated by a corresponding one of the SNR calculation units 106a, 106b, and 106c.

The aperiodic component ratio calculation units 108a, 108b, and 108c each calculate an aperiodic component ratio of the aperiodic component included in the speech, based on the autocorrelation function of the corresponding one of the bandpass signals calculated by a corresponding one of the correlation function calculation units 105a, 105b, and 105c and the correction amount determined by a corresponding one of the correction amount determination units 107a, 107b, and 107c.

The following describes in detail operation of each element.

<Noise Interval Identification Unit 101>

The noise interval identification unit 101 divides an input signal into frames per predetermined length of time, and identifies whether or not each of the frames obtained through the division is a background noise frame as a noise interval in which only background noise is represented or a speech frame as a speech interval in which background noise and speech are represented.

Here, for instance, each of parts divided from the input signal for every 50 msec may be a frame. In addition, a method of identifying whether a frame is a background noise frame or a speech frame is not specifically limited, but, for example, a frame in which power of an input signal exceeds a predetermined threshold may be identified as the speech frame, and other frames may be identified as background speech frames.

<Voiced Speech and Unvoiced Speech Determination Unit 102>

The voiced speech and unvoiced speech determination unit 102 determines whether the speech represented by the input signal in the frame identified as the speech frame by the noise interval identification unit 101 is voiced speech or unvoiced speech. A method of determination is not specifically limited. For instance, when magnitude of a peak of an autocorrelation function or a modified correlation function of speech exceeds a predetermined threshold, speech may be determined as voiced speech.

<Fundamental Frequency Normalization Unit 103>

The fundamental frequency normalization unit 103 analyzes a fundamental frequency of the speech represented by the input signal in the frame identified as the speech frame by the voiced speech and unvoiced speech determination unit 102. A method of analysis is not specifically limited. For example, a fundamental frequency analysis method based on instantaneous frequency (Non-patent Reference 2: T. Abe, T. Kobayashi, S. Imai, “Robust pitch estimation with harmonic enhancement in noisy environment based on instantaneous frequency”, ASVA 97, 423-430 (1996)), which is a robust fundamental frequency analysis method for speech mixed with noise, may be used.

After analyzing the fundamental frequency of the speech, the fundamental frequency normalization unit 103 normalizes the fundamental frequency of the speech into a predetermined target frequency. A method of normalization is not specifically limited. For instance, PSOLA (Pitch-Synchronous OverLap-Add) method (Non-patent Reference 3: F. Charpentier, M. Stella, “Diphone synthesis using an overlap-add technique for speech waveforms concatenation”, Proc. ICASSP, 2015-2018, Tokyo, 1986) makes it possible to change a fundamental frequency of speech and normalize the fundamental frequency into a predetermined target frequency.

This can reduce an influence on an autocorrelation function given by a prosody.

It is to be noted that a target frequency at the time of normalizing speech is not specifically limited, but, for example, setting a target frequency as an average value of fundamental frequencies in a predetermined interval (or, alternatively, all intervals) of speech makes it possible to reduce speech distortion generated by normalizing a fundamental frequency.

For instance, in the PSOLA method, there is a possibility that an autocorrelation value will be excessively increased, because the same pitch waveform is repeatedly used when a fundamental frequency is dramatically increased. On the other hand, when the fundamental frequency is dramatically decreased, the number of missing pitch waveforms increases, and there is a possibility that information on the speech will be lost. Thus, it is preferable to determine a target frequency so that an amount of the change can be as small as possible.

<Frequency Band Division Unit 104>

The frequency band division unit 104 divides, into bandpass signals each associated with a corresponding one of divided bands, the speech having the fundamental frequency normalized by the fundamental frequency normalization unit 103 and the background noise included in the frame identified as the background noise frame by the noise interval identification unit 101, the divided bands being predetermined frequency bands.

A method of division is not specifically limited. For example, a filter may be designed for each of divided bands, and an input signal may be divided into bandpass signals by filtering the input signal.

When a sampling frequency of an input signal is, for instance, 11 kHz, frequency bands predetermined as divided bands may be frequency bands of 0 to 689 Hz, 689 to 1378 Hz, 1378 to 2067 Hz, 2067 to 2756 Hz, 2756 to 3445 Hz, 3445 to 4134 Hz, 4134 to 4823 Hz, and 4823 to 5512 Hz, respectively, which are obtained by dividing a frequency band including 0 to 5.5 kHz into eight equal parts. In this manner, it is possible to separately calculate aperiodic component ratios of aperiodic components included in the bandpass signals each associated with the corresponding one of the divided bands.

It is to be noted that although the present embodiment describes an example where the input signal is divided into the bandpass signals each associated with the corresponding one of the eight divided bands, the division into the eight divided bands is not limited, and it is possible to divide the input signal into four or sixteen divided bands. Increasing the number of divided bands makes it possible to enhance frequency resolution of the aperiodic components. It is to be noted that because the correlation function calculation units 105a to 105c each calculate the autocorrelation function and magnitude of periodicity for the corresponding one of the bandpass signals obtained through the division, it is preferable that a signal corresponding to fundamental periods is included in each band. For example, when speech has a fundamental period of 200 Hz, the division may be performed so that a bandwidth of each of the divided bands becomes equal to or more than 400 Hz.

In addition, it is not necessary to divide a frequency band evenly, and the frequency band may be divided unevenly using, for instance, a mel-frequency axis in accordance with auditory characteristics.

It is preferable to divide the band of the input signal so that the above conditions are satisfied.

<Correlation Function Calculation Units 105a, 105b, and 105c>

The correlation function calculation units 105a, 105b, and 105c each calculate the autocorrelation function of the corresponding one of the bandpass signals obtained through the division performed by the frequency band division unit 104. Where the i-th bandpass signal is xᵢ(n), an autocorrelation function φᵢ(m) of xᵢ(n) can be expressed by Equation 1.

$$\begin{matrix}[ Math 1 ] & \\ {φ}_{i} ( m ) = \frac{1}{M} {\sum }_{n = 0}^{M - 1 - \vert m \vert} {x}_{i} ( n ) {x}_{i} ( n + \vert m \vert ) & ( Equation 1 )\end{matrix}$$

Here, M is the number of sample points included in one frame, n is a serial number of a sample point, and m is an offset value of a sample point.

Where the number of sample points included in one period of the fundamental frequency of the speech analyzed by the fundamental frequency normalization unit 103 is Tₒ, a value calculated in m=Tₒ of the autocorrelation function φᵢ(m) indicates an autocorrelation value of the i-th bandpass signal xᵢ(n) in temporal shift for the one period of the fundamental frequency. In other words, φᵢ(Tₒ) indicates magnitude of periodicity of the i-th bandpass signal xᵢ(n). Thus, the following can be said: periodicity increases as φᵢ(Tₒ) increases; and aperiodicity increases as φᵢ(Tₒ) decreases.

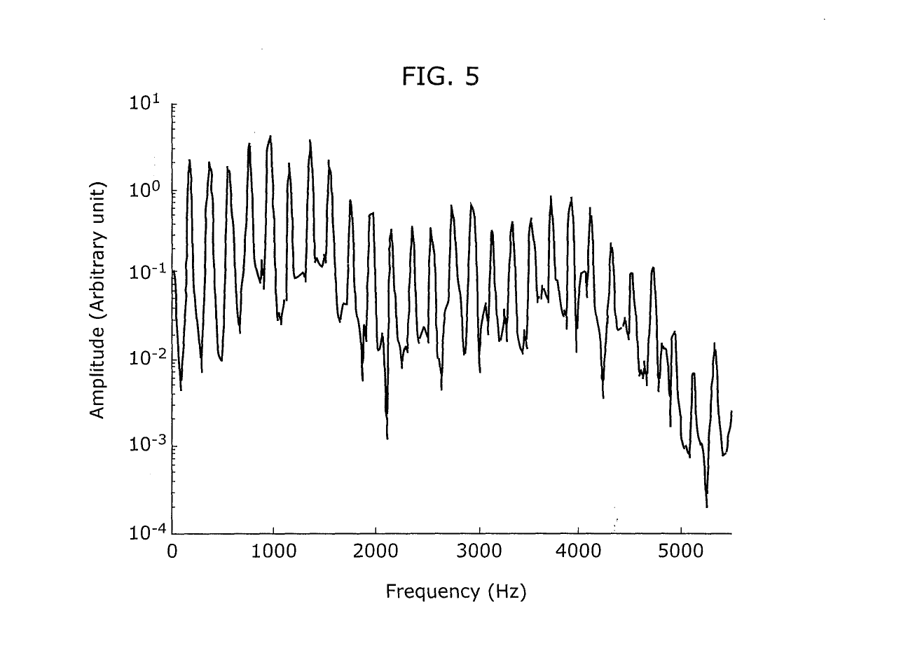

FIG. 5 is a diagram showing an example of an amplitude spectrum in a frame at the center in time of a vowel section of an utterance /a/. It is clear from the figure that harmonics can be discerned from 0 to 4500 Hz and that speech has strong periodicity.

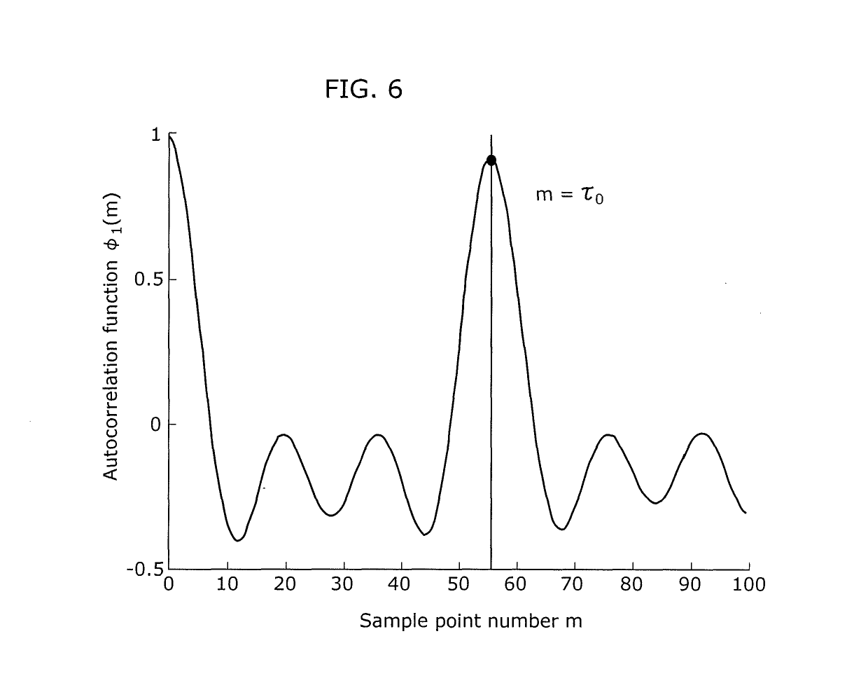

FIG. 6 is a diagram showing an example of an autocorrelation function of the first bandpass signal (frequency band from 0 to 689 Hz) in a central frame of the vowel /a/. In FIG. 6, φᵢ(Tₒ)=0.93 indicates magnitude of periodicity of the first bandpass signal. In the same manner, it is possible to calculate periodicity of each of the second and subsequent bandpass signals.

A peak value is not always obtained through m=Tₒ, because, though variation of an autocorrelation function of a low bandpass signal is relatively slow, an autocorrelation function of a high bandpass signal varies drastically. In this case, it is possible to calculate as periodicity the maximum value among values of several sample points around m=Tₒ.

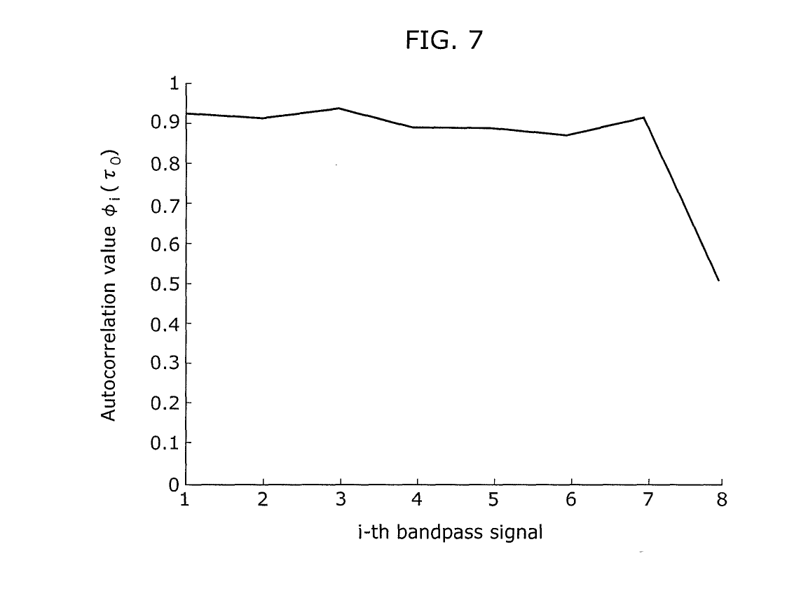

FIG. 7 is a diagram in which a value of autocorrelation function m=Tₒ of each of the first to eighth bandpass signals in the central frame of the aforementioned vowel /a/ is plotted. In FIG. 7, a high autocorrelation value that is equal to or greater than 0.9 is indicated for the first to seventh bandpass signals, which means that the periodicity thereof is high. On the other hand, an autocorrelation value is approximately 0.5 for the eighth bandpass signal, which means that the periodicity thereof is lower. As stated above, using the autocorrelation value of each of the bandpass signals in temporal shift for one period of the fundamental frequency makes it possible to calculate the magnitude of the periodicity for each of the divided bands of the speech.

<SNR Calculation Units 106a, 106b, and 106c>

The SNR calculation units 106a, 106b, and 106c each calculate power of the corresponding one of the bandpass signals divided from the input signal in the background noise frame, hold a value indicating the calculated power, and, when power of a new background noise frame is calculated, update a held value with a value indicating the newly calculated power. This causes each of the SNR calculation units 106a, 106b, and 106c to hold power of immediate background noise.

Furthermore, the SNR calculation units 106a, 106b, and 106c each calculate the power of the corresponding one of the bandpass signals divided from the input signal in the speech frame, and calculate, for each of the divided bands, a ratio between the calculated power in the speech frame and the held power in the immediate background noise frame, as an SN ratio.

For example, where power of an immediate background noise frame is Pᵢ^{N} and power of a speech frame is Pᵢ^{S} for the i-th bandpass signal, SNRᵢ, an SN ratio of the speech frame, is calculated with Equation 2.

$$\begin{matrix}[ Math 2 ] & \\ {SNR}_{i} = 20 {log}_{10} \frac{{P}_{i}^{S}}{{P}_{i}^{N}} & ( Equation 2 )\end{matrix}$$

It is to be noted that the SNR calculation units 106a, 106b, and 106c may each hold an average value of power calculated for a predetermine period or a predetermined number of background noise frames, and calculate an SN ratio using the held average value of the power.

<Correction Amount Determination Units 107a, 107b, and 107c>

The correction amount determination units 107a, 107b, and 107c each determine a correction amount of the aperiodic component ratio calculated by a corresponding one of the aperiodic component ratio calculation units 108a, 108b, and 108c, based on the SN ratio calculated by a corresponding one of the SNR calculation units 106a, 106b, and 106c.

The following describes a specific method of determining correction amount.

The autocorrelation value φᵢ(Tₒ) calculated by each of the correlation function calculation units 105a, 105b, and 105c is influenced by background noise. Specifically, disturbance of amplitude and phase of the bandpass signal by the background noise distorts a periodic structure of a waveform, which results in reduction in the autocorrelation value.

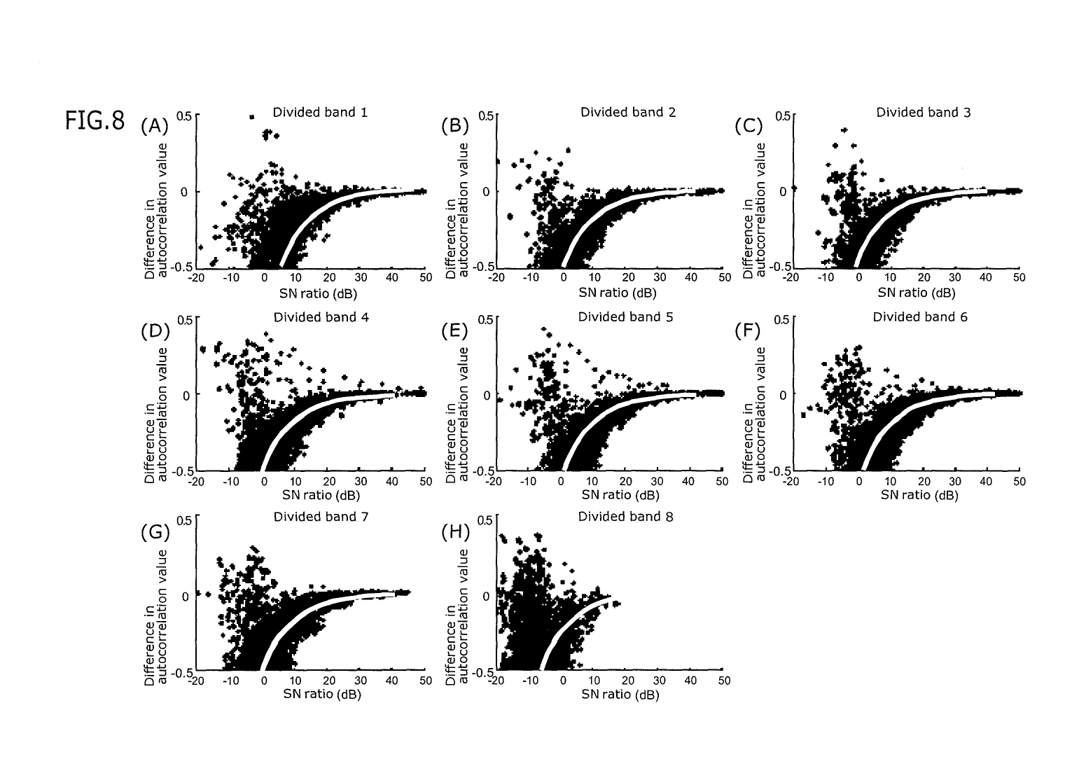

FIGS. 8(A) to 8(H) are diagrams each showing a result of experiment for learning influence of noise on the autocorrelation value φᵢ(Tₒ) calculated by the corresponding one of the correlation function calculation units 105a, 105b, and 105c. In this experiment, an autocorrelation value calculated for speech to which noise is not added and an autocorrelation value calculated for a mixed sound in which noise of various magnitude is added to the speech are compared for each of the divided bands.

In each of graphs shown in FIGS. 8(A) to 8(H), the horizontal axis indicates the SN ratio of each of the bandpass signals, and the vertical axis indicates a difference between the autocorrelation value calculated for the speech to which the noise is not added and the autocorrelation value calculated for the mixed sound in which the noise is added to the speech. One dot represents a difference between the autocorrelation values depending on the presence or absence of the noise in one frame. In addition, a white line indicates a curve obtained by approximating dots with a polynomial equation.

It is clear from FIGS. 8(A) to 8(H) that there is a consistent relationship between the SN ratio and the difference between the autocorrelation values. In other words, the difference approaches zero as the SN ratio increases, and the difference increases as the SN ratio decreases. Further, it is clear that the relationship has a similar tendency in each of the divided bands.

It is conceivable from the relationship that the autocorrelation value of the speech not including the noise can be calculated by correcting, with an amount according to the SN ratio, the autocorrelation value calculated for the mixed sound of the background noise and the speech.

The correction amount according to the SN ratio can be determined by the above-mentioned approximation function indicating the relationship between the SN ratio and the difference between the autocorrelation values depending on the presence or absence of the noise.

It is to be noted that a type of the approximation function is not specifically limited, and it is possible to employ, for example, a polynomial equation, an exponent function, and a logarithmic function.

For instance, when a third-order polynomial equation is employed for the approximation function, a correction amount C is expressed as a third-order function of the SNR ratio (SNR) as shown in Equation 3.

$$\begin{matrix}[ Math 3 ] & \\ C = {\sum }_{p = 0}^{3} {α}_{p} {SNR}^{p} & ( Equation 3 )\end{matrix}$$

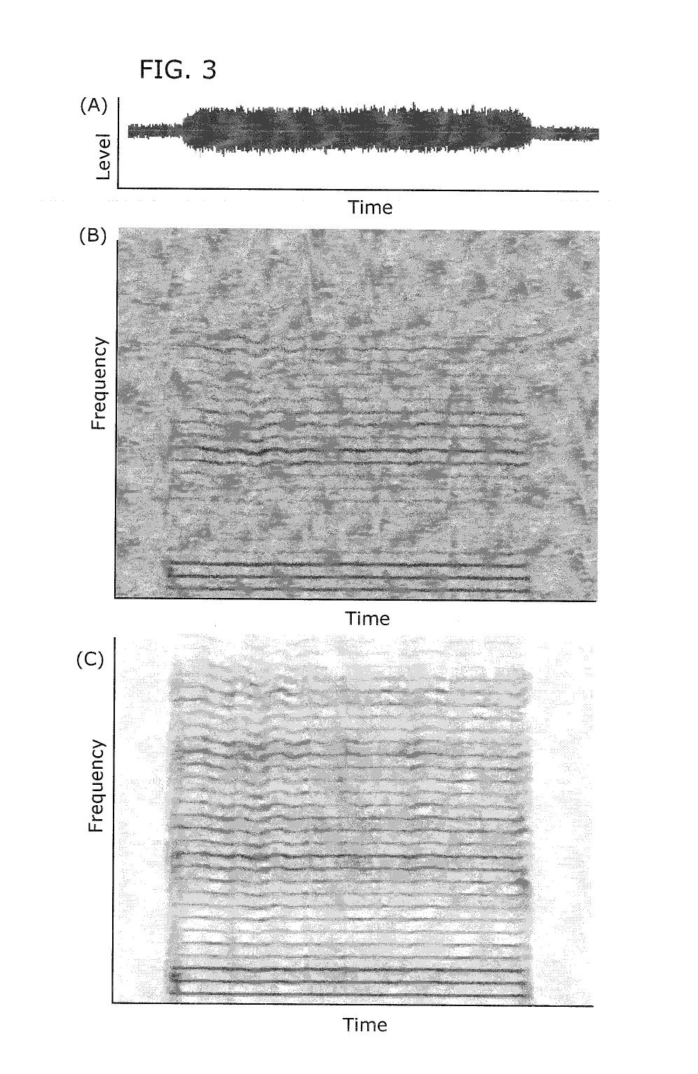

Instead of holding the correction amount as the function of the SN ratio as shown in FIG. 3, an SN ratio may be held in a table in association with a correction amount, and a correction amount corresponding to the SN ratio calculated by each of the SNR calculation units 106a, 106b, and 106c may be referred to from the table.

The correction amount may be determined for each of the bandpass signals obtained through the division performed by the frequency band division unit 104, or may be commonly determined for all of the divided bands. When it is commonly determined, it is possible to reduce an amount of memory for the function or the table.

<Aperiodic Component Ratio Calculation Units 108a, 108b, and 108c>

The aperiodic component ratio calculation units 108a, 108b, and 108c each calculate an aperiodic component ratio based on the autocorrelation function calculated by each of the correlation function calculation units 105a, 105b, and 105c and the correction amount determined by each of the correction amount determination units 107a, 107b, and 107c.

Specifically, aperiodic component ratio APi of the i-th bandpass signal is defined by Equation 4.

[Math 4]

APᵢ=1−(φᵢ(τ₀)−Cᵢ) (Equation 4)

Here, φᵢ(Tₒ) indicates the autocorrelation value in temporal shift for one period of a fundamental frequency of the i-th bandpass signal, and Ci indicates the correction amount determined by each of the correction amount determination units 107a, 107b, and 107c, the autocorrelation value being calculated by each of the correlation function calculation units 105a, 105b, and 105c.

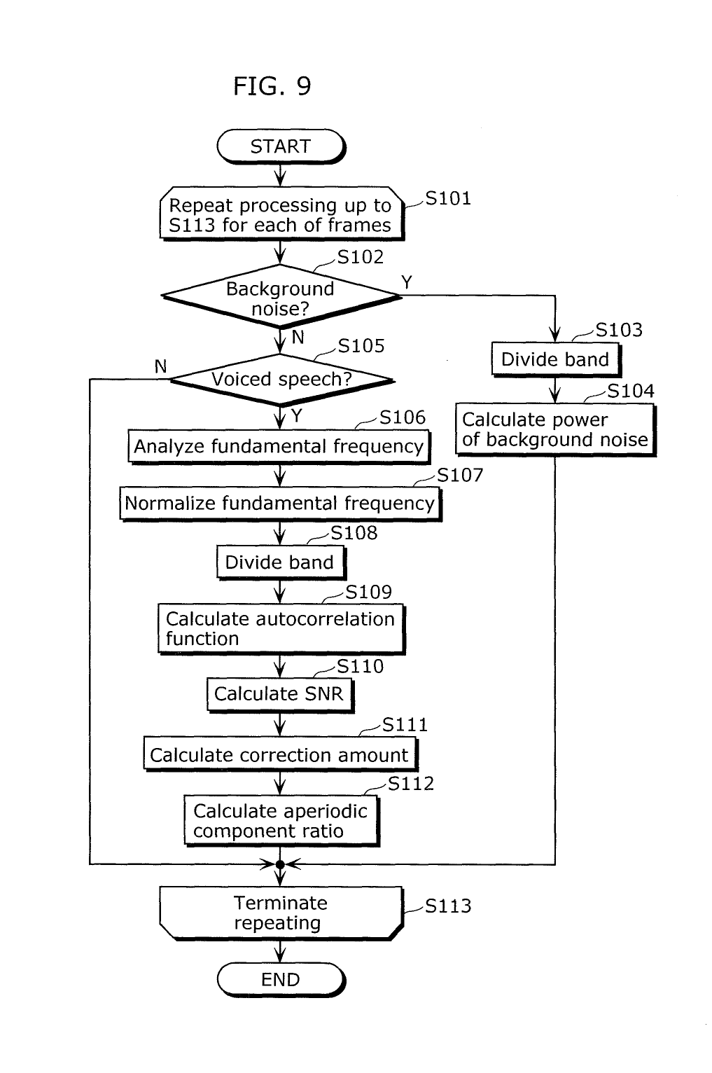

The following describes an example of operations of the speech analysis device 100 thus configured, according to a flow chart shown in FIG. 9.

In Step S101, input speech is divided into frames per predetermined length of time. Operations in Steps S102 to S113 are performed on each of the frames obtained through the division.

In Step S102, it is identified whether each of the frames is a speech frame which is a frame including speech or a background noise frame including only background noise, using the noise interval identification unit 101.

An operation in Step S103 is performed on the frame identified as the background noise frame. On the other hand, an operation in Step S105 is performed on the frame identified as the speech frame.

In Step S103, for the frame identified as the background noise frame in Step S102, the background noise in the frame is divided into bandpass signals each associated with a corresponding one of divided bands which are predetermined frequency bands, using the frequency band division unit 104.

In Step S104, power of each of the bandpass signals obtained through the division in Step S103 is calculated using the SNR calculation units 106a, 106b, and 106c respectively. The calculated power is held, in a corresponding one of the SNR calculation units 106a, 106b, and 106c, as power for each of the divided bands of immediate background noise.

In Step S105, for the frame identified as the speech frame in Step S102, it is determined whether the speech included in the frame is voiced speech or unvoiced speech.

In Step S106, a fundamental frequency of the speech included in the frame for which it is determined that the speech is the voiced speech in Step S105 is analyzed using the fundamental frequency normalization unit 103.

In Step S107, the fundamental frequency of the speech is normalized into a predetermined target frequency based on the fundamental frequency analyzed in Step S106, using the fundamental frequency normalization unit 103.

In Step S108, the speech having the fundamental frequency normalized in Step S107 is divided into bandpass signals each associated with a corresponding one of divided bands which are the same as the divided bands used in dividing the background noise, using the frequency band division unit 104.

In Step S109, an autocorrelation function of each of the bandpass signals obtained through the division in Step S108 is calculated using the correlation function calculation units 105a, 105b, and 105c respectively.

In Step S110, an SN ratio is calculated from the bandpass signal obtained through the division in Step S108 and the power of the immediate background noise held by the operation in Step S104, using the SNR calculation units 106a, 106b, and 106c respectively. Specifically, SNR shown in Equation 2 is calculated.

In Step S111, a correction amount of an autocorrelation value at the time of calculating an aperiodic component ratio of each of the bandpass signals is determined based on the SN ratio calculated in Step S110. Specifically, the correction amount is determined by calculating a value of the function shown in Equation 3 or referring to a table.

In Step S112, the aperiodic component ratio is calculated for each of the divided bands based on the autocorrelation function of each of the bandpass signals calculated in Step S109 and the correction amount determined in Step S111, using the aperiodic component ratio calculation units 108a, 108b, and 108c respectively. Specifically, aperiodic component ratio APᵢ is calculated using Equation 4.

Repeating Steps S102 to S113 for each of the frames makes it possible to calculate aperiodic component ratios for all of the speech frames.

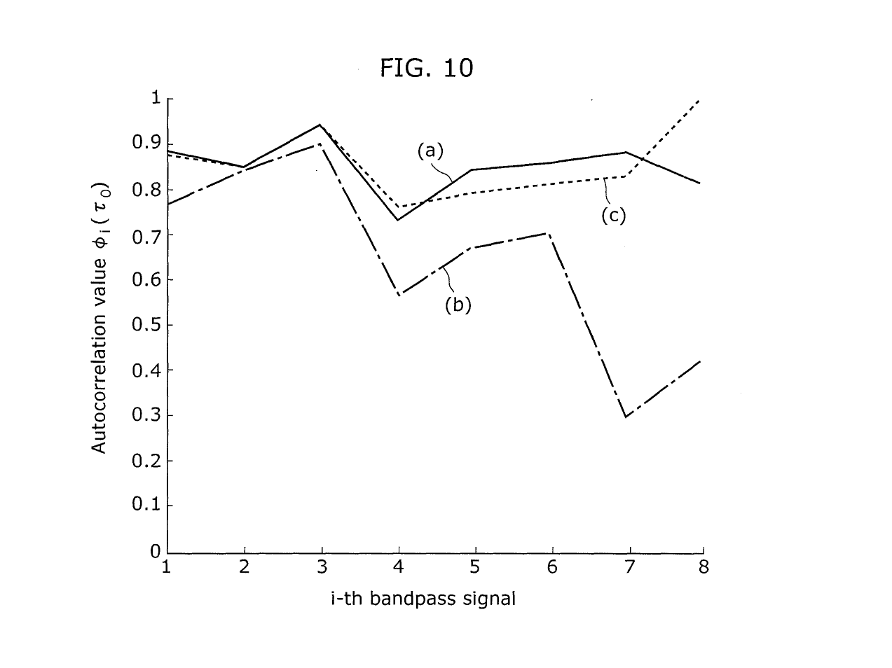

FIG. 10 is a diagram showing a result of analysis of an aperiodic component included in input speech which is performed by the speech analysis device 100.

FIG. 10 is a graph on which autocorrelation value φᵢ(Tₒ) of each of bandpass signals of one frame included in voiced speech of speech having few aperiodic components is plotted. In FIG. 10, graph (a) indicates an autocorrelation value calculated for speech including no background noise, and graph (b) indicates an autocorrelation value calculated for speech to which background noise is added. Graph (c) shows an autocorrelation value to which background noise is added and which is then obtained by considering the correction amounts determined by the correction amount determination units 107a, 107b, and 107c based on the SN ratios calculated by the SNR calculation units 106a, 106b, and 106c.

As is clear from FIG. 10, disturbance of a phase spectrum of each of the bandpass signals by the background noise decreases the correlation value in graph (b), but the autocorrelation value is corrected by the characteristic structure of the present invention, thereby making it possible to obtain an autocorrelation value almost the same as in the case where the speech includes no noise, in graph (c).

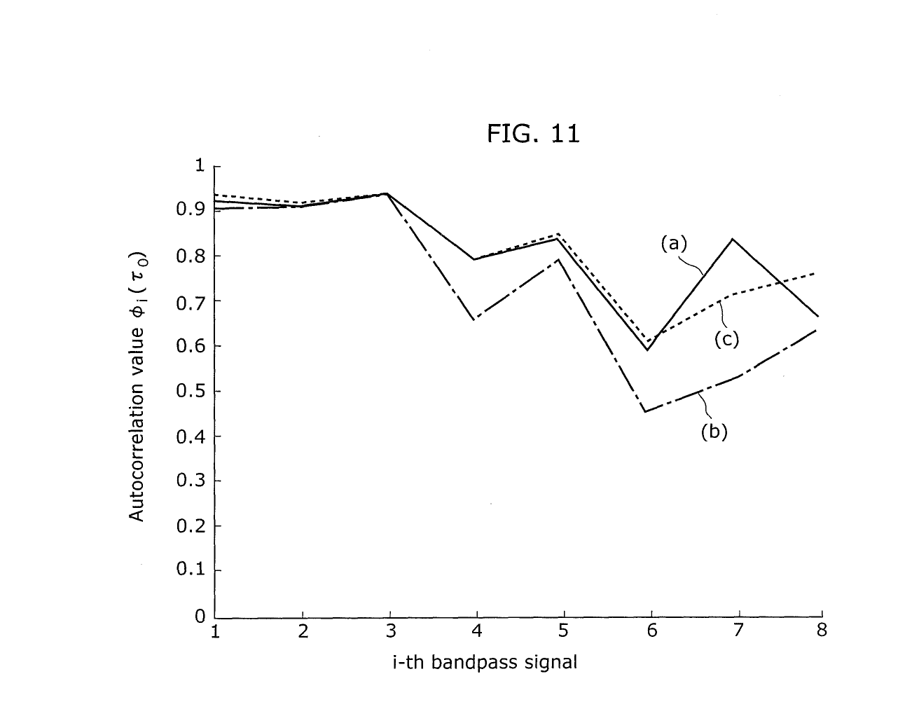

On the other hand, FIG. 11 shows a result of performing the same analysis on speech including many aperiodic components. In FIG. 11, graph (a) shows an autocorrelation value calculated for speech including no background noise, and graph (b) shows an autocorrelation value calculated for speech to which background noise is added. Graph (c) shows an autocorrelation value to which background noise is added and which is then obtained by considering the correction amounts determined by the correction amount determination units 107a, 107b, and 107c based on the SN ratios calculated by the SNR calculation units 106a, 106b, and 106c.

Speech from which the analysis result shown in FIG. 11 is obtained is speech including many aperiodic components in a high-frequency band, but it is possible to obtain an autocorrelation value almost the same as the autocorrelation value of speech to which noise is not added shown by graph (a), by considering the correction amounts determined by the correction amount determination units 107a, 107b, and 107c, like the analysis result shown in FIG. 10.

In other words, the influence on the autocorrelation value by the noise is satisfactorily corrected for either the speech including many aperiodic components or the speech including few aperiodic components, thereby making it possible to accurately analyze an aperiodic component ratio.

As stated above, the speech analysis device of the present invention makes it possible to remove the influence of the noise and accurately analyze the aperiodic component ratio included in the speech even in the practical environment such as a crowd where there is background noise.

Further, it is possible to perform processing without specifying a type of noise in advance, because the correction amount is determined for each of the divided bands based on the SN ratio that is a ratio between the power of the bandpass signal and the power of the background noise. To put it differently, it is possible to accurately analyze the aperiodic component ratio without any previous knowledge about, for instance, whether the type of background noise is white noise or pink noise.

Moreover, using the aperiodic component ratio for each of the divided bands which is obtained from the result of the analysis as individual characteristics of an utterer makes it possible to, for example, generate synthesized speech similar to the speech made by the utterer and perform individual identification of the utterer. The aperiodic component ratio of the speech can be accurately analyzed in the environment where there is the background noise, thereby producing an advantageous effect for such an application in which the aperiodic component ratio is used.

For instance, in an application to voice quality conversion such as karaoke, in consideration of a case where speech of an utterer is converted to be similar to a voice quality of an other utterer, even when there is background noise generated by an unspecified number of people in a karaoke room or the like, an aperiodic component ratio of the speech of the utterer can be accurately analyzed, thereby producing an effect in which the converted speech is very similar to the voice quality of the other utterer.

Furthermore, in an application to individual identification using a mobile phone, an aperiodic component ratio can be accurately analyzed even when speech to be identified is uttered in a crowd such as a train station, thereby producing an effect in which the individual identification can be performed with high reliability.

As described above, the speech analysis device of the present invention performs frequency division of a mixed sound of background noise and speech into bandpass signals, corrects an autocorrelation value calculated for each of the bandpass signals, with a correction amount according to an SN ratio of the bandpass signal, and calculates an aperiodic component ratio using the corrected autocorrelation value, thereby making it possible to accurately analyze the aperiodic component ratio of the speech itself in an practical environment where there is background noise.

The aperiodic component ratio of each of the bandpass signals can be used for generating, as individual characteristics of an utterer, synthesized speech similar to speech made by the utterer and performing individual identification of the utterer. In such an application in which the aperiodic component ratio is used, the use of the speech analysis device of the present invention makes it possible to increase an utterer similarity of the synthesized speech and enhance the reliability of individual identification.

(Example of Application to Speech Analysis and Synthesis Device)

The following describes, as an application example of the speech analysis device of the present invention, a speech analysis and synthesis device and a speech analysis and synthesis method which generate synthesized speech using an aperiodic component ratio obtained from an analysis.

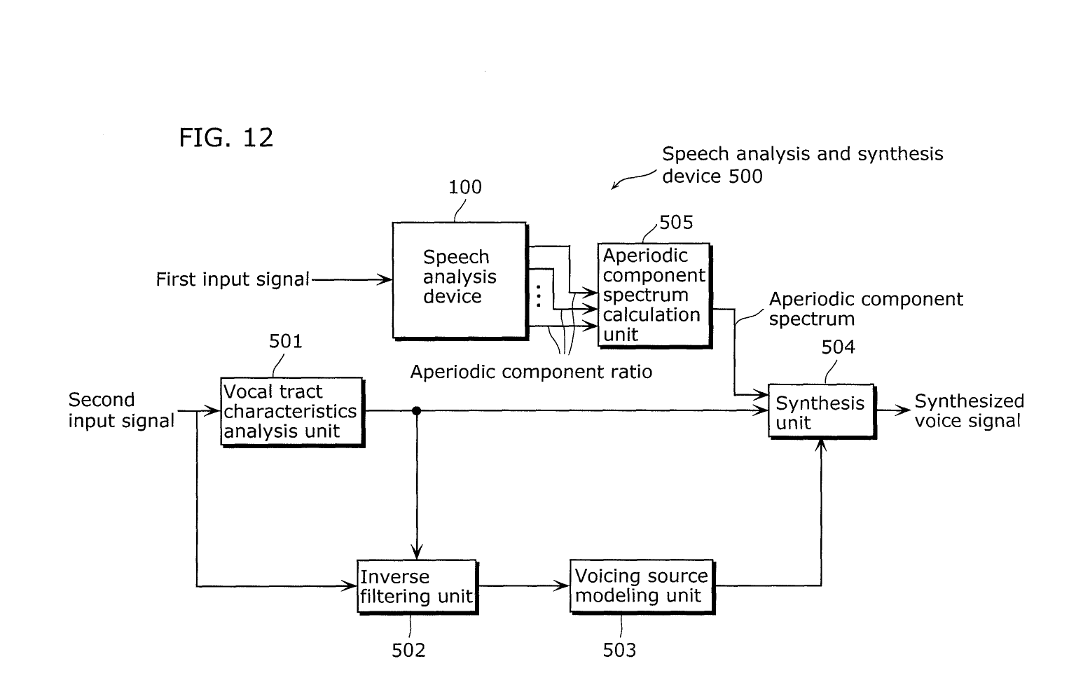

FIG. 12 is a block diagram showing an example of a functional configuration of a speech analysis and synthesis device 500 according to the application example of the present invention.

The speech analysis and synthesis device 500 of FIG. 12 is a device which analyzes a first input signal representing a mixed sound of background noise and first speech and a second input signal representing a second speech, and reproduces, in the second speech represented by the second input signal, an aperiodic component of the first speech represented by the first input signal. The speech analysis and synthesis device 500 includes a speech analysis device 100, a vocal tract characteristics analysis unit 501, an inverse filtering unit 502, a voicing source modeling unit 503, a synthesis unit 504, and an aperiodic component spectrum calculation unit 505.

It is to be noted that the first speech and the second speech may be the same speech. In this case, the aperiodic component of the first speech is applied at the same time as the second speech. When the first speech and the second speech are different, a temporal correspondence between the first speech and the second speech is obtained in advance, and an aperiodic component at a corresponding time is to be reproduced.

The speech analysis device 100 is the speech analysis device 100 shown in FIG. 4, and outputs, for each of divided bands, an aperiodic component ratio of the first speech represented by the first input signal.

The vocal tract characteristics analysis unit 501 performs an LPC (Linear Predictive Coding) analysis on the second speech represented by the second input signal, and calculates a linear predictive coefficient corresponding to vocal tract characteristics of an utterer of the second speech.

The inverse filtering unit 502 performs inverse filtering on the second speech using the linear predictive coefficient analyzed by the vocal tract characteristics analysis unit 501, and calculates an inverse filter waveform corresponding to voicing source characteristics of the utterer of the second speech.

The voicing source modeling unit 503 models the voicing source waveform outputted by the inverse filtering unit 502.

The aperiodic component spectrum calculation unit 505 calculates an aperiodic component spectrum indicating a frequency distribution of magnitude of an aperiodic component ratio, from the aperiodic component ratio for each of frequency bands which is the output of the speech analysis device 100.

The synthesis unit 504 receives, as an input, the linear predictive coefficient analyzed by the vocal tract characteristics analysis unit 501, a voicing source parameter analyzed by the voicing source modeling unit 503, and the aperiodic component spectrum calculated by the aperiodic component spectrum calculation unit 505, and synthesizes the aperiodic component of the first speech with the second speech.

<Vocal Tract Characteristics Analysis Unit 501>

The vocal tract characteristics analysis unit 501 performs a linear predictive analysis on the second speech represented by the second input signal. The linear predictive analysis is a process in which sample value yₙ of a speech waveform is predicted from a p number of sample values, and a model equation to be used for the prediction can be expressed as Equation 5.

[Math 5]

yₙ≈α₁yₙ₋₁+α₂yₙ₋₂+α₃yₙ₋₃+Λ+αₚyₙ₋ₚ (Equation 5)

Coefficient αᵢ for the p number of sample values can be calculated using, for instance, a correlation method and a covariance method. Defining z transformation using the calculated coefficient αᵢ allows a speech signal to be expressed by Equation 6.

$$\begin{matrix}[ Math 6 ] & \\ S ( z ) = \frac{1}{A ( z )} U ( z ) & ( Equation 6 )\end{matrix}$$

Here, U(z) indicates a signal for which inverse filtering is performed on input speech S(z) using 1/A(z).

<Inverse Filtering Unit 502>

The inverse filtering unit 502 forms a filter having inverse characteristics to a frequency response, using the linear predictive coefficient analyzed by the vocal tract characteristics analysis unit 501, and extracts a voicing source waveform of the speech by filtering the second speech represented by the second input signal.

<Voicing Source Modeling Unit 503>

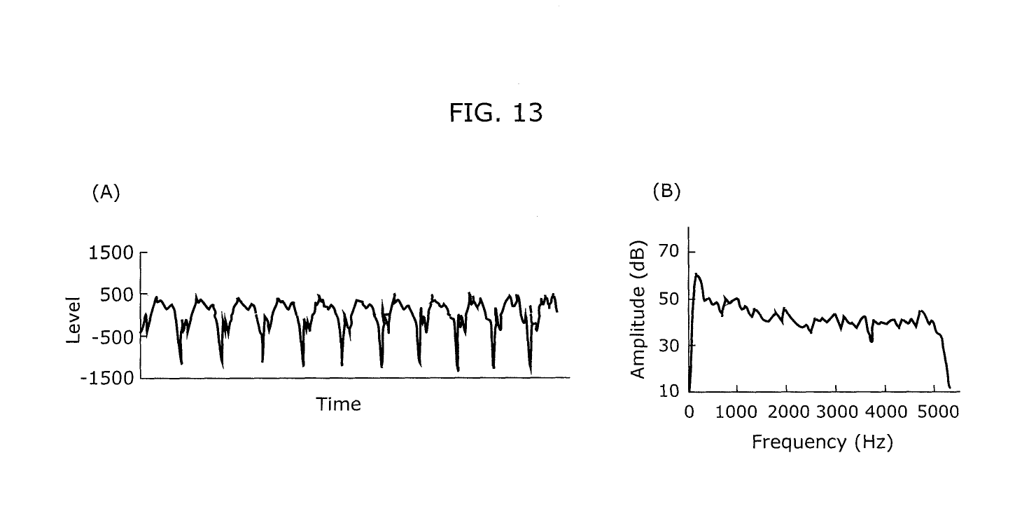

FIG. 13(A) is a diagram showing an example of a waveform outputted by the inverse filtering unit 502. FIG. 13(B) is a diagram showing an amplitude spectrum of the waveform.

The inverse filtering indicates estimation of information for a vocal-cord voicing source by removing transfer characteristics of a vocal tract from speech. Here, obtained is a temporal waveform similar to a differentiated glottal volume velocity waveform, which is assumed in such models as the Rosenberg-Klatt model. The former waveform has a structure finer than the waveform of the Rosenberg-Klatt model, because the Rosenberg-Klatt model is a model using a simple function and therefore cannot represent a temporal fluctuation inherent in each of individual vocal cord waveforms and other complicated vibrations.

The vocal-cord voicing source waveform thus estimated (hereinafter referred to as “voicing source waveform”) is modeled by the following method:

1. A glottal closure time for the voicing source waveform is estimated per pitch period. This estimation method includes, for instance, a method disclosed in Patent Reference: Japanese Patent No. 3576800.

2. The voicing source waveform is taken per pitch period, centering on the glottal closure time. For the taking, the Hanning window function having nearly twice the length of the pitch period is used.

3. The waveform, which is taken, is converted into a frequency domain representation using discrete Fourier transform (hereinafter, referred to as DFT).

4. A phase component is removed from each frequency component in DFT, to thereby generate amplitude spectrum information. For removal of the phase component, the frequency component represented by a complex number is replaced by an absolute value in accordance with the following Equation 7.

[Math 7]

z=\sqrt{x²+y²} (Equation 7)

Here, z indicates an absolute value, x indicates a real part, and y indicates an imaginary part.

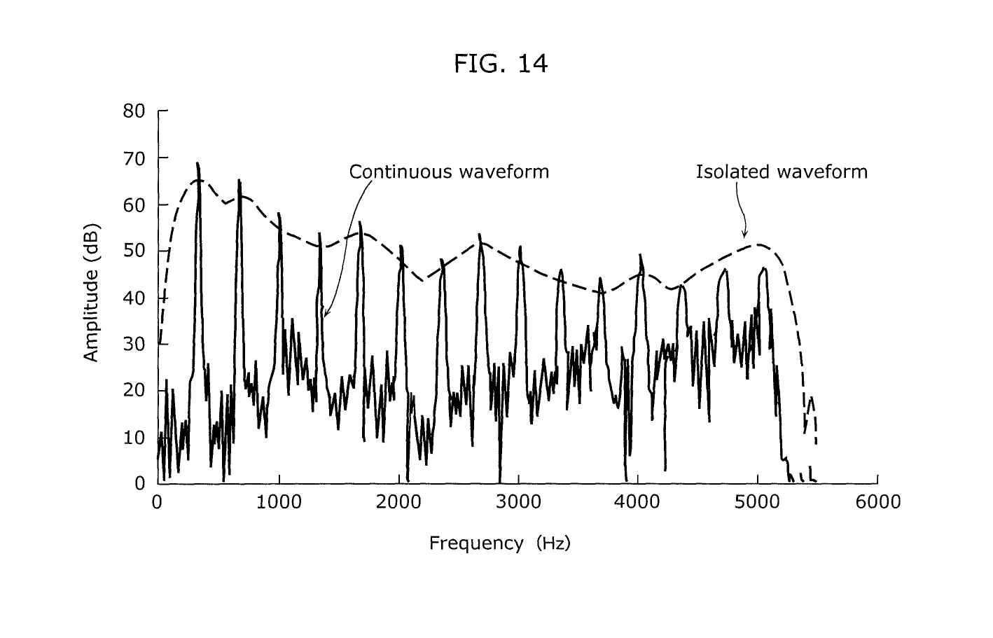

FIG. 14 is a diagram showing a voicing-source amplitude spectrum thus generated.

In FIG. 14, a solid-line graph shows an amplitude spectrum when the DFT is performed on a continuous waveform. The continuous waveform includes a harmonic structure accompanying a fundamental frequency, and thus an amplitude spectrum to be obtained intricately varies and it is difficult to perform a process of changing the fundamental frequency and the like. On the other hand, a dashed-line graph shows an amplitude spectrum when the DFT is performed on an isolated waveform obtained by taking one pitch period, using the voicing source modeling unit 503.

As is clear from FIG. 14, performing the DFT on the isolated waveform makes it possible to obtain an amplitude spectrum corresponding to an envelope of an amplitude spectrum of the continuous waveform without being influenced by a fundamental period. Using the voicing-source amplitude spectrum thus obtained makes it possible to change voicing-source information such as the fundamental frequency.

<Synthesis Unit 504>

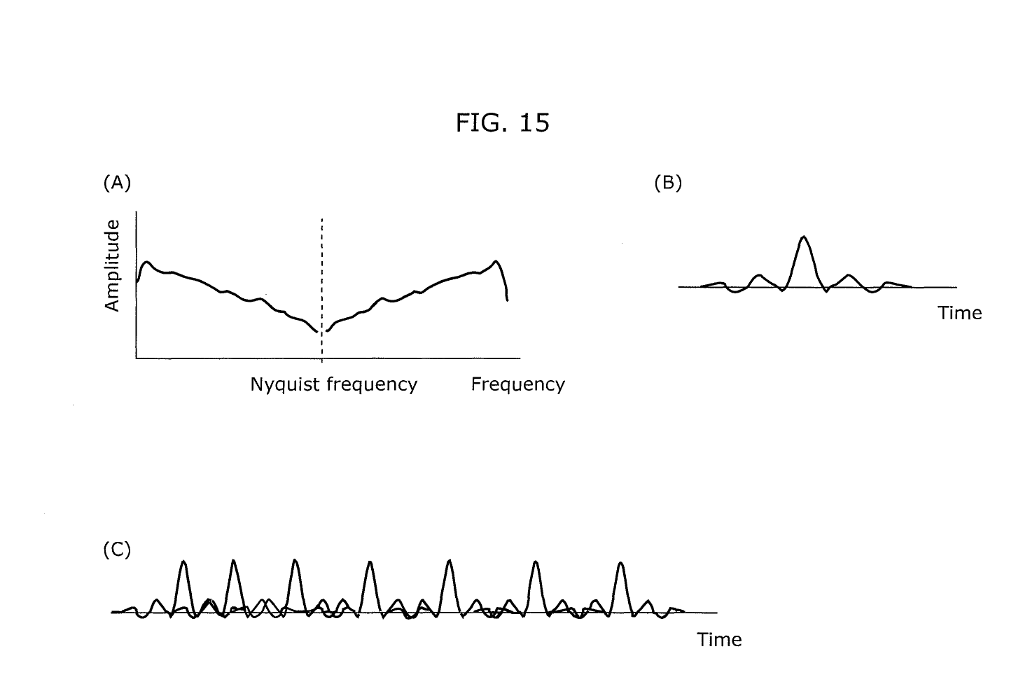

The synthesis unit 504 drives a filter analyzed by the vocal tract characteristics analysis unit 501, using the voicing source based on the voicing source parameter analyzed by the voicing source modeling unit 503, so as to generate synthesized speech. Here, the aperiodic component included in the first speech is reproduced in the synthesized speech by transforming phase information of a voicing-source waveform using the aperiodic component ratio analyzed by the speech analysis device of the present invention. The following describes an example of a method of generating a voicing-source waveform with reference to FIGS. 15(A) to 15(C).

The synthesis unit 504 creates a symmetrical amplitude spectrum by folding back, at a boundary of a Nyquist frequency (half a sampling frequency) as shown in FIG. 15(A), an amplitude spectrum of the voicing-source parameter modeled by the voicing source modeling unit 503.

The synthesis unit 504 transforms the amplitude spectrum thus created into a temporal waveform, using inverse discrete Fourier transform (IDFT). The synthesis unit 504 generates a continuous voicing-source waveform by overlapping such waveforms, so as to obtain a desired pitch period, as shown in FIG. 15(C), because the waveform thus transformed is a bilaterally symmetrical waveform having a length of one pitch period as shown in FIG. 15(B).

In FIG. 15(A), the amplitude spectrum does not include phase information. It is possible to synthesize the aperiodic component of the first speech with the second speech by adding, to the amplitude spectrum, the phase information (hereinafter, referred to as phase spectrum) including a frequency distribution, using the aperiodic component ratio for each of the frequency bands obtained through the analysis of the first speech performed by the speech analysis device 100.

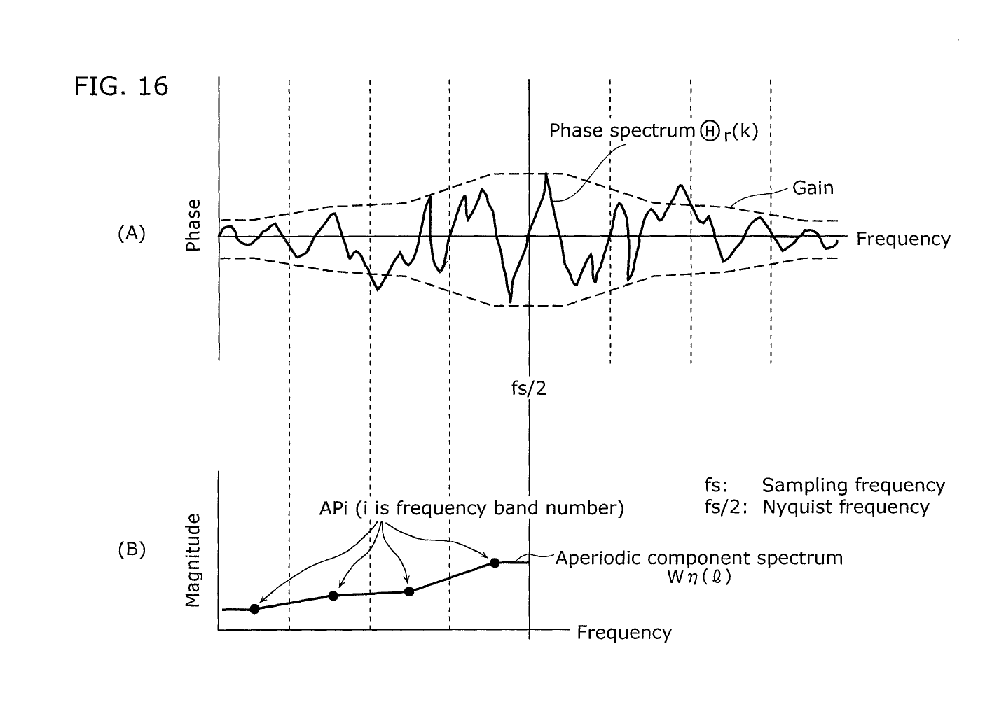

The following describes a method of adding a phase spectrum with reference to FIGS. 16(A) and 16(B).

FIG. 16(A) is a graph on which an example of phase spectrum θᵣ is plotted, with the vertical axis indicating a phase and the horizontal axis indicating a frequency. The solid-line graph shows a phase spectrum to be added to a waveform of a voicing source, and a random number sequence for which a frequency band is limited, the waveform having a length of one pitch period. In addition, the solid-line graph is symmetrical with respect to a point at a boundary of a Nyquist frequency. The dashed-line graph shows a gain added to the random number sequence. In FIG. 16(A), the gain is added using a curve which rises higher from a lower frequency to a higher frequency (Nyquist frequency). The gain is added according to a frequency distribution of magnitude of an aperiodic component.

The frequency distribution of the magnitude of the aperiodic component is called an aperiodic component spectrum, and the aperiodic component spectrum is determined by interpolating, at a frequency axis, the aperiodic component ratio calculated for each of the frequency bands, as shown in FIG. 16(B). FIG. 16(B) shows, as an example, aperiodic component spectrum wη(l) obtained by performing linear interpolation on aperiodic component ratio APᵢ at a frequency axis, the aperiodic component ratio APᵢ being calculated for each of four frequency bands. The aperiodic component ratio APᵢ of each of the frequency bands may be all of frequencies in the frequency band without performing the interpolation.

Specifically, when voicing-source waveform g′(n) obtained by randomizing a group delay of voicing-source waveform g(n) (for example, FIG. 15(B)) having a length of one pitch period is determined, the phase spectrum θᵣ is set as shown by Equations 8A to 8C.

$$\begin{matrix}[ Math 8 ] & \\ {Θ}_{r} ( k ) = \{ \begin{matrix}{η}^{′} ( k ) , k = 0 , K , \frac{N}{2} \\ - {η}^{′} ( - k ) , k = - \frac{N}{2} + 1 , K , - 1\end{matrix} & ( Equation 8 A ) \\ {η}^{′} ( k ) = \frac{2 π}{N} {\sum }_{l = 0}^{k} {w}_{η} ( l ) η ( l ) & ( Equation 8 B ) \\ η ( l ) = r ( l ) / {σ}_{r} & ( Equation 8 C )\end{matrix}$$

Here, N indicates fast Fourier transform (FFT) size, r(l) indicates a random number sequence for which a frequency band is limited, σᵣ indicates a standard deviation of r(l), and wη(l) indicates an aperiodic component ratio in frequency l. FIG. 16(A) shows an example of the generated phase spectrum θᵣ.

Using the phase spectrum θᵣ thus generated makes it possible to create the voicing-source waveform g′(n) to which the aperiodic component is added, according to Equations 9A and 9B.

$$\begin{matrix}[ Math 9 ] & \\ {g}^{′} ( n ) = \frac{1}{\sqrt{N}} {\sum }_{k = - N / 2 + 1}^{N / 2} {G}^{′} ( \frac{2 π}{N} k ) {e}^{j 2 π k / N} & ( Equation 9 A ) \\ {G}^{′} ( \frac{2 π}{N} k ) = G ( \frac{2 π}{N} k ) {e}^{- {jΘ}_{r} ( k )} & ( Equation 9 B )\end{matrix}$$

Here, G(2π/N·k) is a DFT coefficient of g(n), and is expressed by Equation 10.

$$\begin{matrix}[ Math 10 ] & \\ G ( \frac{2 π}{N} k ) = \frac{1}{\sqrt{N}} {\sum }_{n = 0}^{N - 1} g ( n ) {e}^{- j2π k / N} & ( Equation 10 )\end{matrix}$$

Using the voicing-source waveform g′(n) to which the aperiodic component corresponding to the phase spectrum θᵣ thus generated makes it possible to synthesize the waveform having the length of one pitch period. The continuous voicing-source waveform is generated by overlapping such waveforms, so as to obtain the same pitch period as in FIG. 15(C). Each time a different sequence is used for the random number sequence.

The speech to which the aperiodic component is added can be generated from the voicing-source waveform thus generated, by driving the vocal tract filter analyzed by the vocal tract characteristics analysis unit 501, using the synthesis unit 504. This makes it possible to add breathiness and softness to a voiced-speech source by adding a random phase to each of corresponding frequency bands.

Therefore, even when speech uttered in a noisy environment is used, it is possible to reproduce aperiodic components such as breathiness and softness which are individual characteristics.

### Embodiment 2

It has been described in Embodiment 1 that there is the consistent relationship between the amount of influence given to the autocorrelation value of the speech by the noise (that is, a degree of difference between the autocorrelation value calculated for the speech and the autocorrelation value calculated for the mixed sound of the speech and the noise) and the SN ratio between the speech and the noise, the consistent relationship being indicated by appropriate correction rule information (for instance, the approximate function expressed by the third-order polynomial equation).

It has been also described that each of the correction amount determination units 107A to 107C of the speech analysis device 100 calculates the autocorrelation value of the speech including no noise by correcting, with the correction amount determined from the correction rule information according to the SN ratio, the autocorrelation value calculated for the mixed sound of the background noise and the speech.

Embodiment 2 of the present invention describes a correction rule information generating device which generates correction rule information used in determining the correction amount by each of the correction amount determination units 107A to 107C of the speech analysis device 100.

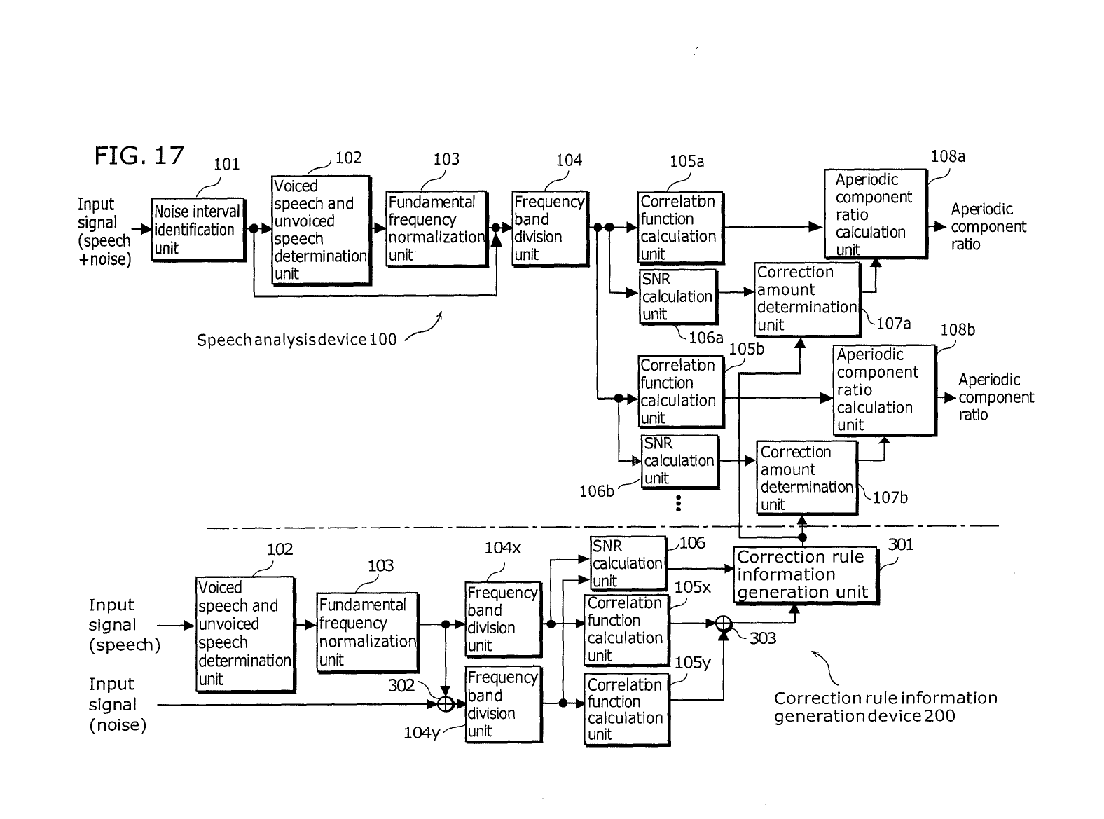

FIG. 17 is a block diagram showing an example of a functional configuration of a correction rule information generating device 200 according to Embodiment 2 of the present invention. FIG. 17 shows the speech analysis device 100 described in Embodiment 1 together with the correction rule information generating device 200.

The correction rule information generating device 200 in FIG. 17 is a device which generates correction rule information indicating a relationship between (i) a difference between an autocorrelation value of speech and an autocorrelation value of a mixed sound of the speech and noise and (ii) an SN ratio, based on an input signal representing previously prepared speech and an input signal representing previously prepared noise. The correction rule information generating device 200 includes a voiced speech and unvoiced speech determination unit 102, a fundamental frequency normalization unit 103, an addition unit 302, frequency band division units 104x and 104y, correlation function calculation units 105x and 105y, a subtraction unit 303, an SNR calculation unit 106, and a correction rule information generating unit 301.

The same numerals are assigned to, among the elements of the correction rule information generating device 200, the elements having common functions as the elements of the speech analysis device 100.

The correction rule information generating device 200 may be, for example, a computer system including a central processor, a memory, and so on. In this case, a function of each of the elements of the correction rule information generating device 200 is realized as a function of software to be exerted by the central processor executing a program stored in the memory. In addition, the function of each of the elements of the correction rule information generating device 200 can be realized by using a digital signal processing device or a dedicated hardware device.

The voiced speech and unvoiced speech determination unit 102 included in the correction rule information generating device 200 receives speech frames representing previously prepared speech for each predetermined length of time, and determines whether the speech represented by each of speech frames is voiced speech or unvoiced speech.

The fundamental frequency normalization unit 103 analyzes a fundamental frequency of the speech determined as the voiced speech by the voiced speech and unvoiced speech determination unit 102, and normalizes the fundamental frequency of the speech into a predetermined target frequency.

The frequency band division unit 104x divides, into bandpass signals each associated with a corresponding one of divided bands, the speech having the fundamental frequency normalized into the predetermined target frequency by the fundamental frequency normalization unit 103, the divided bands being predetermined different frequency bands.

The addition unit 302 mixes a noise frame representing previously prepared noise with the speech frame, so as to generate a mixed sound frame representing a mixed sound of the noise and the speech, the speech frame representing the speech having the fundamental frequency normalized into the predetermined target frequency by the fundamental frequency normalization unit 103.

The frequency band division unit 104y divides the mixed sound generated by the addition unit 302 into the bandpass signals each associated with the corresponding one of the divided bands that are the same divided bands used by the frequency band division unit 104x.

The SNR calculation unit 106 calculates, as an SN ratio, a ratio of power between each of bandpass signals of speech data obtained by the frequency band division unit 104x and the corresponding one of the bandpass signals of the mixed sound obtained by the frequency band division unit 104y, for each of the divided bands. The SN ratio is calculated per divided band and frame.

The correlation function calculation unit 105x determines an autocorrelation value by calculating an autocorrelation function of each of the bandpass signals of the speech data obtained by the frequency band division unit 104x, and the correlation function calculation unit 105y determines an autocorrelation value by calculating an autocorrelation function of each of the bandpass signals of the mixed speech of the speech and the noise obtained by the frequency band division unit 104y. Each of the autocorrelation values is determined as a value of an autocorrelation function in temporal shift for one period of the fundamental frequency of the speech obtained as the result of analysis performed by the fundamental frequency normalization unit 103.

The subtraction unit 303 calculates a difference between the autocorrelation value of each of the bandpass signals of the speech determined by the correlation function calculation unit 105x and the correlation value of each of the bandpass signals corresponding to the mixed sound determined by the correlation function calculation unit 105y. The difference is calculated per divided band and frame.

The correction rule information generation unit 301 generates, for each of the divided bands, correction rule information indicating a relationship between an amount of influence given to the autocorrelation value of the speech by the noise (that is, the difference calculated by the subtraction unit 303) and the SN ratio calculated by the SNR calculation unit 106.

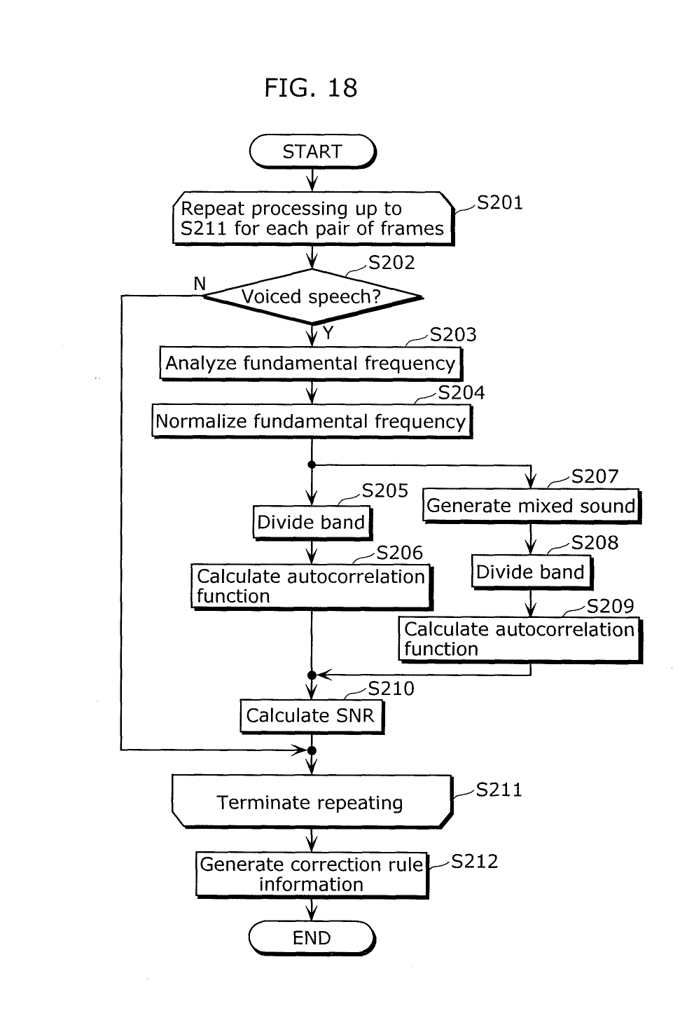

The following describes an example of operations of the correction rule information generating device 200 thus configured, according to a flow chart shown in FIG. 18.

In Step S201, a noise frame and speech frames are received, and operations in Steps S202 to S210 are performed on a pair of each of the received speech frames and the noise frame.

In Step S202, it is determined whether speech in a current speech frame is voiced speech or unvoiced speech, using the voiced speech and unvoiced speech determination unit 102. When it is determined that the speech is the voiced speech, the operations in Steps S203 to S210 are performed. When it is determined that the speech is the unvoiced speech, a next pair is processed.

In Step S203, a fundamental frequency of speech included in the frame for which it is determined that the speech is the voiced speech in Step S202 is analyzed using the fundamental frequency normalization unit 103.

In Step S204, the fundamental frequency of the speech is normalized into a predetermined target frequency based on the fundamental frequency analyzed in Step S203, using the fundamental frequency normalization unit 103.

A target frequency for normalization is not specifically limited. The fundamental frequency of the speech may be normalized into a predetermined frequency, and may be also normalized into an average fundamental frequency of input speech.

In Step S205, the speech having the fundamental frequency normalized in Step S204 is divided into bandpass signals each associated with a corresponding one of divided bands, using the frequency band division unit 104x.

In Step S206, an autocorrelation function of each of the bandpass signals divided from the speech in Step S205 is calculated using the correlation function calculation unit 105x, and a value of the autocorrelation function in a position of a fundamental period represented by an inverse number of the fundamental frequency calculated in Step S203 is an autocorrelation value of the speech.

In Step S207, the speech frame having the fundamental frequency normalized in Step S204 and the noise frame are mixed to generate a mixed sound.

In Step S208, the mixed sound generated in Step S207 is divided into bandpass signals each associated with a corresponding one of divided bands, using the frequency band division unit 104y.

In Step S209, an autocorrelation function of each of the bandpass signals divided from the mixed sound in Step S208 is calculated using the correlation function calculation unit 105y, and a value of the autocorrelation function in a position of a fundamental period represented by an inverse number of the fundamental frequency calculated in Step S203 is an autocorrelation value of the mixed sound.

It is to be noted that the operations in Steps S205 and S206 and the operations in Steps S207 to S209 may be performed in parallel or successively.

In Steps S210, an SN ratio is calculated, for each of the divided bands, based on each of the bandpass signals of the speech calculated in Step S205 and each of the bandpass signals of the mixed sound calculated in Step S208, using the SNR calculation unit 106. A method of calculation may be the same as in Embodiment 1, as shown in Equation 2.

In Step S211, repetition is controlled until the operations in Steps S202 to S210 are performed on all of the pairs of the noise frame and each speech frame. As a result, the SN ratio between the speech and the noise, the autocorrelation value of the speech, and the autocorrelation value of the mixed sound are determined per divided band and frame.

In Step S212, correlation rule information is generated based on the SN ratio between the speech and the noise, the autocorrelation value of the speech, and the autocorrelation value of the mixed sound that are determined per divided band and frame, using the correction rule information generation unit 301.

Specifically, a distribution shown in each of FIGS. 8(A) to 8(H) is obtained by holding, for each divided band and each frame, the correction amount and the SN ratio between the speech frame and the mixed sound frame calculated in Step S210, the correction amount being the difference between the autocorrelation value of the speech and the autocorrelation value of the mixed sound that are calculated in Step S203.

Correction rule information representing the distribution is generated. For example, when the distribution is approximated by the third-order polynomial equation as shown in Equation 3, each of coefficients of the polynomial equation is generated as the correction rule information due to regression analysis. It is to be noted that, as mentioned in Embodiment 1, the correction rule information may be expressed by the table storing the SN ratio and the correction amount in association with each other. In this manner, the correction rule information (for instance, an approximation function and a table) indicating the correction amount of the autocorrelation value based on the SN ratio is generated per divided band.

The correction rule information thus generated is outputted to each of the correction amount determination units 107A to 107C included in the speech analysis device 100. The speech analysis device 100 operates using the given correction rule information, so that the speech analysis device 100 makes it possible to remove the influence of noise and analyze the aperiodic component included in the speech even in an actual environment such as a crowd where there is background noise.

Further, it is not necessary to specify a type of noise in advance, because the correction amount is calculated for each of the divided bands based on a power ratio between the bandpass signal and noise in different bands. Stated differently, it is possible to accurately analyze the aperiodic component without any previous knowledge about, for instance, whether the type of background noise is white noise or pink noise.

### INDUSTRIAL APPLICABILITY

The speech analysis device of the present invention is useful as a device which accurately analyzes a aperiodic component ratio that is individual characteristics included in speech in a practical environment where there is background noise. In addition, the speech analysis device is useful for the application to the speech synthesis and individual identification for which the analyzed aperiodic component ratio is used as the individual characteristics.

What is claimed is:

1. A speech analysis device which analyzes an aperiodic component included in speech from an input signal representing a mixed sound of background noise and the speech, said speech analysis device comprising:
a frequency band division unit configured to divide the input signal into bandpass signals each associated with a corresponding one of frequency bands;
a noise interval identification unit configured to identify a noise interval in which the input signal represents only the background noise and a speech interval in which the input signal represents the background noise and the speech;
an SNR calculation unit configured to calculate an SN ratio which is a ratio between power of each of the bandpass signals divided from the input signal in the speech interval and power of each of the bandpass signals divided from the input signal in the noise interval;
a correlation function calculation unit configured to calculate an autocorrelation function of each of the bandpass signals divided from the input signal in the speech interval;
a correction amount determination unit configured to determine a correction amount for an aperiodic component ratio, based on the calculated SN ratio; and
an aperiodic component ratio calculation unit configured to calculate, for each of the frequency bands, an aperiodic component ratio of the aperiodic component included in the speech, based on the determined correction amount and the calculated autocorrelation function.

2. The speech analysis device according to claim 1,
wherein said correction amount determination unit is configured to determine, as the correction amount for the aperiodic component ratio, a correction amount that increases as the calculated SN ratio decreases.

3. The speech analysis device according to claim 1,
wherein said aperiodic component ratio calculation unit is configured to calculate, as the aperiodic component ratio, a ratio that increases as a correction correlation value decreases, the correction correlation value being obtained by subtracting the correction amount from a value of the autocorrelation function in temporal shift for one period of a fundamental frequency of the input signal.

4. The speech analysis device according to claim 1,
wherein said correction amount determination unit is configured to hold in advance correction rule information indicating a correspondence of an SN ratio to a correction amount, refer to a correction amount corresponding to the calculated SN ratio according to the correction rule information, and determine the correction amount referred to as the correction amount for the aperiodic component ratio.

5. The speech analysis device according to claim 1,
wherein said correction amount determination unit is configured to hold in advance an approximation function as the correction rule information, calculate a value of the approximation function based on the calculated SN ratio, and determine the calculated value as the correction amount for the aperiodic component ratio, the approximation function indicating a relationship between a correction amount and an SN ratio, the relationship being learned based on a difference between an autocorrelation value of speech and an autocorrelation value in the case where noise having a known SN ratio is superimposed on the speech.

6. The speech analysis device according to claim 1, further comprising
a fundamental frequency normalization unit configured to normalize a fundamental frequency of the speech into a predetermined target frequency,
wherein said aperiodic component ratio calculation unit is configured to calculate the aperiodic component ratio using the speech having the fundamental frequency normalized.

7. The speech analysis device according to claim 6,
wherein said fundamental frequency normalization unit is configured to normalize the fundamental frequency of the speech into an average value of the fundamental frequency in a predetermined unit of the speech.

8. The speech analysis device according to claim 7,
wherein the predetermined unit is one of a phoneme, a syllable, a mora; an accentual phrase, a phrase, and a whole sentence.

9. A speech analysis and synthesis device which analyzes an aperiodic component included in first speech from a first input signal representing a mixed sound of background noise and the first speech, and synthesizes the analyzed aperiodic component into second speech represented by a second input signal, said speech analysis and synthesis device comprising:
a frequency band division unit configured to divide the first input signal into bandpass signals each associated with a corresponding one of frequency bands;
a noise interval identification unit configured to identify a noise interval in which the first input signal represents only the background noise and a speech interval in which the first input signal represents the background noise and the first speech;
an SNR calculation unit configured to calculate an SN ratio which is a ratio between power of each of the bandpass signals divided from the first input signal in the speech interval and power of each of the bandpass signals divided from the first input signal in the noise interval;
a correlation function calculation unit configured to calculate an autocorrelation function of each of the bandpass signals divided from the first input signal in the speech interval;
a correction amount determination unit configured to determine a correction amount for an aperiodic component ratio, based on the calculated SN ratio;
an aperiodic component ratio calculation unit configured to calculate, for each of the frequency bands, an aperiodic component ratio of the aperiodic component included in the first speech, based on the determined correction amount and the calculated autocorrelation function;
an aperiodic component spectrum calculation unit configured to calculate an aperiodic component spectrum indicating a frequency distribution of the aperiodic component, based on the aperiodic component ratio calculated for each of the frequency bands;
a vocal tract characteristics analysis unit configured to analyze vocal tract characteristics for the second speech;
an inverse filtering unit configured to extract a voicing-source waveform of the second speech by performing inverse filtering on the second speech using characteristics inverse to the analyzed vocal tract characteristics;
a voicing-source modeling unit configured to model the extracted voicing-source waveform; and
a synthesis unit configured to synthesize speech based on the analyzed vocal tract characteristics, the modeled voicing-source characteristics, and the calculated aperiodic component spectrum.

10. A correction rule information generation device comprising:
a frequency band division unit configured to divide, into same bandpass signals each associated with a corresponding one of divided bands, an input signal representing speech and an other input signal representing noise, respectively, the divided bands being frequency bands;
an SNR calculation unit configured to calculate, for each of the divided bands, an SN ratio which is a ratio between power of the speech and power of the noise in each of different time intervals, based on each of the bandpass signals obtained through the division;
a correlation function calculation unit configured to calculate, for each of the divided bands, an autocorrelation value of the speech and an autocorrelation value of the speech in each of the different time intervals, based on each of the bandpass signals obtained through the division; and
a correction rule information generating unit configured to generate, for each of the divided bands, correction rule information, based on the calculated SN ratio, the autocorrelation value of the speech, and the autocorrelation value of the noise, the correction rule information indicating a correspondence of a difference between the autocorrelation value of the speech and the autocorrelation value of the noise to the SN ratio.

11. A speech analysis system comprising:
a speech analysis device which analyzes an aperiodic component included in speech from an input signal representing a mixed sound of background noise and the speech; and
a correction rule information generating device, wherein said speech analysis device includes:
a frequency band division unit configured to divide the input signal into bandpass signals each associated with a corresponding one of frequency bands;
a noise interval identification unit configured to identify a noise interval in which the input signal represents only the background noise and a speech interval in which the input signal represents the background noise and the speech;
an SNR calculation unit configured to calculate an SN ratio which is a ratio between power of each of the bandpass signals divided from the input signal in the speech interval and power of each of the bandpass signals divided from the input signal in the noise interval;
a correlation function calculation unit configured to calculate an autocorrelation function of each of the bandpass signals divided from the input signal in the speech interval;
a correction amount determination unit configured to determine a correction amount for an aperiodic component ratio, based on the calculated SN ratio; and
an aperiodic component ratio calculation unit configured to calculate, for each of the frequency bands, an aperiodic component ratio of the aperiodic component included in the first speech, based on the determined correction amount and the calculated autocorrelation function,
said correction rule information generating device includes:
a frequency band division unit configured to divide, into same bandpass signals each associated with a corresponding one of divided bands, an input signal representing speech and an other input signal representing noise, respectively, the divided bands being frequency bands;
an SNR calculation unit configured to calculate, for each of the divided bands, an SN ratio which is a ratio between power of the speech and power of the noise in each of different time intervals, based on each of the bandpass signals obtained through the division;
a correlation function calculation unit configured to calculate, for each of the divided bands, an autocorrelation value of the speech and an autocorrelation value of the speech in each of the different time intervals, based on each of the bandpass signals obtained through the division; and
a correction rule information generating unit configured to generate, for each of the divided bands, correction rule information, based on the calculated SN ratio, the autocorrelation value of the speech, and the autocorrelation value of the noise, the correction rule information indicating a correspondence of a difference between the autocorrelation value of the speech and the autocorrelation value of the noise to the SN ratio, and
said speech analysis device refers to a correction amount corresponding to the calculated SN ratio according to the correction rule information generated by said correction rule information generating device, and determine the correction amount referred to as the correction amount for the aperidoic component ratio.

12. A speech analysis method of analyzing an aperiodic component included in speech from an input signal representing a mixed sound of background noise and the speech, said speech analysis method comprising:
dividing the input signal into bandpass signals each associated with a corresponding one of frequency bands;
identifying a noise interval in which the input signal represents only the background noise and a speech interval in which the input signal represents the background noise and the speech;
calculating an SN ratio which is a ratio between power of each of the bandpass signals divided from the input signal in the speech interval and power of each of the bandpass signals divided from the input signal in the noise interval;
calculating an autocorrelation function of each of the bandpass signals divided from the first input signal in the speech interval;
determining a correction amount for an aperiodic component ratio, based on the calculated SN ratio; and
calculating, for each of the frequency bands, an aperiodic component ratio of the aperiodic component included in the speech, based on the determined correction amount and the calculated autocorrelation function.

13. A correction rule information generating method comprising:
dividing, into same bandpass signals each associated with a corresponding one of divided bands, an input signal representing speech and an other input signal representing noise, respectively, the divided bands being frequency bands;
calculating, for each of the divided bands, an SN ratio which is a ratio between power of the speech and power of the noise in each of different time intervals, based on each of the bandpass signals obtained in said dividing;
a correlation function calculation unit configured to calculate, for each of the divided bands, an autocorrelation value of the speech and an autocorrelation value of the speech in each of the different time intervals, based on each of the bandpass signals obtained in said dividing; and
generating, for each of the divided bands, correction rule information, based on the calculated SN ratio, the autocorrelation value of the speech, and the autocorrelation value of the noise, the correction rule information indicating a correspondence of a difference between the autocorrelation value of the speech and the autocorrelation value of the noise to the SN ratio.

14. A computer-executable program for analyzing an aperiodic component included in speech from an input signal representing a mixed sound of background noise and the speech, said computer-executable program causing a computer to execute:
dividing the input signal into bandpass signals each associated with a corresponding one of frequency bands;
identifying a noise interval in which the input signal represents only the background noise and a speech interval in which the input signal represents the background noise and the speech;
calculating an SN ratio which is a ratio between power of each of the bandpass signals divided from the input signal in the speech interval and power of each of the bandpass signals divided from the input signal in the noise interval;
calculating an autocorrelation function of each of the bandpass signals divided from the first input signal in the speech interval;
determining a correction amount for an aperiodic component ratio, based on the calculated SN ratio; and
calculating, for each of the frequency bands, an aperiodic component ratio of the aperiodic component included in the speech, based on the determined correction amount and the calculated autocorrelation function.

15. A program recorded on a computer-readable medium, said program causing a computer to execute:
dividing, into same bandpass signals each associated with a corresponding one of divided bands, an input signal representing speech and an other input signal representing noise, respectively, the divided bands being frequency bands;
calculating, for each of the divided bands, an SN ratio which is a ratio between power of the speech and power of the noise in each of different time intervals, based on each of the bandpass signals obtained in said dividing;
calculating, for each of the divided bands, an autocorrelation value of the speech and an autocorrelation value of the speech in each of the different time intervals, based on each of the bandpass signals obtained through the division; and
generating, for each of the divided bands, correction rule information, based on the calculated SN ratio, the autocorrelation value of the speech, and the autocorrelation value of the noise, the correction rule information indicating a correspondence of a difference between the autocorrelation value of the speech and the autocorrelation value of the noise to the SN ratio.
